(19) United States
(12) Patent Application Publication
(10) Pub. No.: US 2026/0184340 A1
(43) Pub. Date: Jul. 2, 2026

(54) AUTONOMOUS VEHICLE TRAJECTORY GENERATION AND MOTION CONTROL

(71) Applicant: Aurora Operations, Inc., Pittsburgh, PA (US)

(72) Inventors: Kalin Vasilev Gochev, Pittsburgh, PA (US); Sagar Suhas Joshi, Sunnyvale, CA (US); Venkatraman Narayanan, Mountain View, CA (US); Dongping Qi, Pittsburgh, PA (US)

(21) Appl. No.: 19/006,471

(22) Filed: Dec. 31, 2024

(51) Int. Cl. B60W 60/00; B60W 40/13

(52) U.S. Cl. CPC B60W 60/0011; B60W 40/13; B60W 2520/105; B60W 2530/10; B60W 2540/18; B60W 2552/15; B60W 2552/30; B60W 2555/60; B60W 2556/40

(57) ABSTRACT

An example method includes obtaining road data, vehicle state data, and platform limit data associated with an autonomous vehicle; generating a velocity profile and a lateral profile associated with the autonomous vehicle based on the road data, vehicle state data, and platform limit data; generating a plurality of initial candidate trajectories for the autonomous vehicle based on the velocity profile and the lateral profile; determining, from among the plurality of initial candidate trajectories, a selected trajectory for the autonomous vehicle; and providing one or more instructions to control a motion of the autonomous vehicle in accordance with the selected trajectory.

### BACKGROUND

An autonomous platform can process data to perceive an environment through which the autonomous platform travels. For example, an autonomous vehicle can perceive its environment using a variety of sensors and identify objects around the autonomous vehicle. The autonomous vehicle can identify an appropriate path through the perceived surrounding environment and navigate along the path with minimal or no human input.

### SUMMARY

Example implementations of the present disclosure can improve the ability of an autonomous vehicle to generate dynamically feasible motion trajectories. In particular, the autonomous vehicle can process road data, vehicle state data, and vehicle-based platform limits to generate a plurality of initial candidate trajectories that are all executable by the autonomous vehicle, given its current state. For example, the autonomous vehicle can process road data, vehicle state data, and vehicle-based platform limits to generate a velocity profile and a lateral profile that can then be leveraged to provide for guided sampling or guided trajectory generation. The autonomous vehicle can then generate a plurality of initial candidate trajectories that conform to the generated trajectory parameters (e.g., conform to the velocity profile and the lateral profile). The parameter-based generation can provide for a more directed trajectory generation by limiting the generation to a domain that is feasible for the autonomous vehicle, while conforming to the platform limits. This approach reduces the computational cost of generating the candidate trajectories (or sampling therefrom). In particular, the generation of initial candidate trajectories that are mechanically impossible can be mitigated or altogether eliminated.

In an example, an autonomous vehicle can obtain data descriptive of road geometry, a vehicle state, and platform limits based on the vehicle. The data can then be processed to determine profiles (e.g., a velocity profile, an acceleration profile, a jerk profile, or a lateral profile) for constraining the initial candidate trajectory generation (or sampling). In some implementations, the profiles can be dynamic based on a plurality of different context data points (e.g., the vehicle, the cargo, the road condition, the weather, the route, the road gradient, proximity to other vehicles, or other context information). The road geometry can indicate the curvature, elevation, or other characteristics of the road on which the autonomous is/will be traveling. The vehicle state can describe an initial/current velocity, acceleration, heading, or position of the vehicle. The platform limits can indicate, for example, the acceleration limit, jerk limit, velocity limit, steering limit, or steering rate limit of the autonomous vehicle. For example, the autonomous vehicle in a current context may be limited in the jerk capabilities and acceleration capabilities based on engine specifications, cargo load, weight distribution, or other factors.

The autonomous vehicle can process the data to generate a velocity profile and a lateral profile. The velocity profile can indicate a range of velocities attainable by the autonomous vehicle based on the initial/current state of the autonomous vehicle and the acceleration limit. The lateral profile can indicate a range of lateral offsets from a path of the autonomous vehicle that are achievable by the autonomous vehicle based on the initial/current state of the autonomous vehicle and the one or more steering limits.

For example, the autonomous vehicle can process the vehicle state data, the platform limit data, and a determined jerk range to determine an acceleration range, which can then be leveraged to determine a velocity range for generating the velocity profile. The jerk range can be descriptive of a range of rates of change of acceleration that can occur without violating platform limits for the autonomous vehicle in the current context. The acceleration range can be descriptive of a range of rates of change of velocity that can occur without violating platform limits for the autonomous vehicle in the current context. Similarly, the velocity range can be descriptive of the velocities that can be performed (e.g., during a particular time horizon) without violating the platform limits. For example, the autonomous vehicle may determine the profiles based on a particular time horizon that may be associated with prediction horizons for a length of trajectories being generated (or sampled) (e.g., profiles may be generated based on a set of time associated with a length of time utilized for trajectory predictions (e.g., the length of the trajectory as related to time)). The autonomous vehicle may set a target time, compute the minimum and maximum target speed achievable at the target time given the current autonomous vehicle state and dynamics limits. The autonomous vehicle can then ensure that the target speed is between the minimum and maximum achievable speed.

The autonomous vehicle can determine a lateral motion range for generating the lateral profile, in parallel or in series to the velocity range determination. For example, the platform limit data can include data descriptive of a steering angle limit and an acceleration steering angle limit. The autonomous vehicle can process the steering angle limit, the acceleration steering angle limit, and the road data to determine the lateral motion range. The lateral motion range can be descriptive of a left steering limit and a right steering limit.

The autonomous vehicle can then generate a plurality of initial candidate trajectories based on the velocity profile and the lateral profile. For instance, the initial candidate trajectories refer to the first candidate trajectories generated by the autonomy system of the autonomous vehicle, within a particular planning cycle. By way of example, for a first planning cycle, the autonomous vehicle can generate a plurality of initial candidate trajectories (based on the velocity/lateral profiles), that can then be ranked and selected for execution by the autonomous vehicle. The autonomous vehicle can implement the selected trajectory by providing one or more instructions (e.g., to a vehicle controller) to control a motion of the autonomous vehicle in accordance with the selected trajectory.

The motion planner of the autonomous vehicle can continually obtain updated data, generate candidate trajectories, and evaluate/select the trajectories, in subsequent planning cycles. In this way, for each planning cycle, the autonomous vehicle can determine a particular trajectory to execute without the computational cost of generating and evaluating candidate trajectories that are not plausible for the autonomous vehicle.

The techniques of the present disclosure can provide a number of technical effects and benefits that improve the functioning of the autonomous vehicle and the autonomous vehicle computing systems. For instance, previous approaches can include generating a large dataset of initial candidate trajectories, which includes trajectories that may not be dynamically feasible for execution by the autonomous vehicle. Such trajectories may not be dynamically feasible because the candidate trajectories conflict with the physical capabilities of autonomous vehicles. The conflicting trajectories may be a relatively large portion of the candidate trajectories. While these candidate trajectories may be filtered in a downstream operation, such approaches introduce a technical problem because the approaches lead to the autonomous vehicle utilizing its limited onboard processing resources to generate candidate trajectories that are not even possible for the autonomous vehicle to execute. Additionally, with larger datasets of candidate trajectories, the computational cost of the candidate trajectory evaluation can also be more expensive as each of the candidate trajectories would need to be evaluated for, at least, the downstream filtering process.

The systems and methods disclosed herein provide a technical solution to this technical problem by implementing upstream process techniques to produce dynamically feasible, initial candidate trajectories. For instance, as described herein, the systems and methods process the current state of the travel way of the vehicle, vehicle itself, and the physical operating limits of the vehicle (e.g., given its current circumstances) and generate profiles (e.g., velocity/lateral profiles) that can guide the initial candidate trajectory generation process. The autonomous vehicle can generate fewer initial candidate trajectories, while ensuring the candidate trajectories that are generated are plausible with regards to the capabilities of the autonomous vehicle. Accordingly, the technology of the present disclosure reduces the computational cost for motion planning, while maintaining quality.

Additionally, the autonomous vehicle can generate the initial candidate trajectories in a manner that helps to reduce potential latency. For example, the quantity of initial candidate trajectories can be greatly reduced while maintaining, or even increasing, candidate trajectory quality. The reduction in computational resources leveraged can reduce prediction time, allow for redistribution of resources for trajectory evaluation, or allow for more frequent prediction to provide improved overall motion planning and vehicle control.

In some implementations, the velocity or lateral profiles may be utilized for trajectory validation or trajectory auditing. For example, a testing system may validate the trajectories of a motion planning system by providing test sensor data, test road data, and test vehicle state data to the motion planning system. The test data may represent a particular test scenario designed to evaluate the performance of the motion planning system. The motion planning system may process the test data utilizing the technology provided herein (e.g., in combination with the vehicle platform limit data) and generate initial candidate trajectories. The testing system may analyze the heading, velocity, steering, and acceleration parameters of the initial candidate trajectories to validate that each of the trajectories is dynamically feasible by the autonomous vehicle. Additionally, or alternatively, the testing system can evaluate the trajectory executed by the autonomous vehicle. The evaluation can be utilized to validate the autonomous vehicle executed a trajectory without interruption or operator intervention.

In an auditing operation/mode, a computing system may analyze log data of an autonomous vehicle to determine whether the autonomous vehicle has met a particular industry/regulatory standard (e.g., X interventions per Y miles). For example, the autonomous vehicle, or a remote system associated therewith, may generate log data indicative of candidate trajectories or executed trajectories. An auditing system may process the log data to determine whether the applicable standard by flagging any trajectories that appear outside the physical limits of the autonomous vehicle or required operator intervention due to the infeasibility of the trajectory. The technology of the present disclosure can ensure that candidate, as well as executed, trajectories will meet such standards because, for example, the platform limit data may be partly based on vehicle specifications or regulatory requirements, which can be leveraged to generate profiles that can be indicative of both mechanical feasibility and regulatory compliance.

The techniques of the present disclosure can provide a number of technical effects and benefits that improve the functioning of the autonomous vehicle and its computing systems and advance the field of autonomous driving as a whole.

In an aspect, the present disclosure provides an example method for autonomous vehicle motion planning and control. The example method includes obtaining road data, vehicle state data, and platform limit data associated with an autonomous vehicle. The road data is indicative of one or more characteristics of one or more roads within an environment of the autonomous vehicle. The vehicle state data is indicative of a state of the autonomous vehicle. The platform limit data is indicative of an acceleration limit and one or more steering limits of the autonomous vehicle. The example method includes generating a velocity profile and a lateral profile associated with the autonomous vehicle based on the road data, vehicle state data, and platform limit data. The velocity profile indicates a range of velocities performable by the autonomous vehicle based on the state of the autonomous vehicle and the acceleration limit. The lateral profile indicates a range of lateral offsets from a path of the autonomous vehicle that are performable by the autonomous vehicle based on the state of the autonomous vehicle and the one or more steering limits. The example method includes generating a plurality of initial candidate trajectories for the autonomous vehicle based on the velocity profile and the lateral profile. The plurality of initial candidate trajectories are feasible for execution by the autonomous vehicle based on dynamic limits associated with velocities and lateral movement described in the velocity profile and the lateral profile. The example method includes determining, from among the plurality of initial candidate trajectories, a selected trajectory for the autonomous vehicle. The example method includes providing one or more instructions to control a motion of the autonomous vehicle in accordance with the selected trajectory.

In some implementations, the range of velocities of the velocity profile are performable by the autonomous vehicle at a target time based on the state of the autonomous vehicle, the acceleration limit, the one or more steering limits, and the characteristics of the one or more roads.

In some implementations, the range of lateral offsets of the lateral profile are achievable by the autonomous vehicle at a target distance based on the state of the autonomous vehicle, the acceleration limit, the one or more steering limits, and the characteristics of the one or more roads.

In some implementations, the one or more steering limits include at least one of a steering angle limit or a steering angle rate limit.

In some implementations, the state of the autonomous vehicle includes an initial velocity and an initial acceleration of the autonomous vehicle. In some implementations, the example method includes determining a jerk range based on the vehicle state data and the platform limit data. The jerk range is indicative of a maximum jerk and a minimum jerk based on the initial velocity and the initial acceleration. In some implementations, the example method includes determining an acceleration range based on the vehicle state data, the platform limit data, and the jerk range. In some implementations, the acceleration range is indicative of a maximum acceleration and a minimum acceleration that is determined based on the jerk range, the acceleration limit, the initial velocity, and the initial acceleration. In some implementations, the range of velocities is indicative of a maximum velocity and a minimum velocity based on the acceleration range, the jerk range, the acceleration limit, the initial velocity, and the initial acceleration.

In some implementations, the lateral profile is indicative of a lateral motion range descriptive of a left steering limit and a right steering limit.

In some implementations, the example method includes obtaining a vehicle identifier descriptive of a particular model of the autonomous vehicle. In some implementations, the example method includes obtaining, based on the vehicle identifier, vehicle specification information. In some implementations, the vehicle specification information is indicative of an engine of the autonomous vehicle, a size of the autonomous vehicle, and a weight of the autonomous vehicle. In some implementations, the example method includes generating the platform limit data based on the road data and the vehicle specification information.

In some implementations, the example method includes obtaining vehicle specification information for the autonomous vehicle. In some implementations, the vehicle specification information is indicative of an engine of the autonomous vehicle, a size of the autonomous vehicle, and a weight of the autonomous vehicle. In some implementations, the example method includes obtaining load information indicative of a load weight of a cargo of the autonomous vehicle. In some implementations, the example method includes determining the platform limit data based on the load weight and the vehicle specification information. In some implementations, the example method includes obtaining load distribution information indicative of a weight distribution of the cargo including weight densities in relation to a front and a back of the autonomous vehicle and generating the platform limit data based on the load weight, the load distribution information, and the vehicle specification information.

In some implementations, the example method includes obtaining map information indicative of the one or more roads. In some implementations, the map information is indicative of at least one of one or more gradients for the one or more roads, traffic sign information for the one or more roads, or one or more curvatures for the one or more roads. In some implementations, the example method includes generating the road data based on at least one of the one or more gradients for the one or more roads, the traffic sign information for the one or more roads, and the one or more curvatures for the one or more roads.

In some implementations, the example method includes obtaining route information indicative of a current route of the autonomous vehicle. In some implementations, the example method includes determining a next navigation event for the autonomous vehicle based on the current route based on the route information. In some implementations, the next navigation event is descriptive of a next turn for the current route. In some implementations, the example method includes identifying the next navigation event is within a time horizon associated with a current trajectory planning cycle. In some implementations, the example method includes generating the plurality of initial candidate trajectories also based on the next navigation event.

In an aspect, the present disclosure provides an example autonomous vehicle control system for controlling an autonomous vehicle. In some implementations, the example autonomous vehicle control system includes one or more processors and one or more non-transitory computer-readable media storing instructions that are executable by the one or more processors to cause the computing system to perform operations. The operations include obtaining road data, vehicle state data, and platform limit data associated with the autonomous vehicle. The road data is indicative of one or more characteristics of one or more roads within an environment of the autonomous vehicle. The vehicle state data is indicative of a state of the autonomous vehicle. The platform limit data is indicative of an acceleration limit and one or more steering limits of the autonomous vehicle. The operations include generating a velocity profile and a lateral profile associated with the autonomous vehicle based on the road data, vehicle state data, and platform limit data. The velocity profile indicates a range of velocities performable by the autonomous vehicle based on the state of the autonomous vehicle and the acceleration limit. The lateral profile indicates a range of lateral offsets from a path of the autonomous vehicle that are performable by the autonomous vehicle based on the state of the autonomous vehicle and the one or more steering limits. The operations include generating a plurality of initial candidate trajectories for the autonomous vehicle based on the velocity profile and the lateral profile. The plurality of initial candidate trajectories are feasible for execution by the autonomous vehicle based on dynamic limits associated with velocities and lateral movement described in the velocity profile and the lateral profile. The operations include determining, from among the plurality of initial candidate trajectories, a selected trajectory for the autonomous vehicle. The operations include providing one or more instructions to control a motion of the autonomous vehicle in accordance with the selected trajectory.

In some implementations, the autonomous vehicle includes one or more sensors, and the operations include obtaining sensor data via the one or more sensors and generating the vehicle state data based on the sensor data.

In some implementations, the range of velocities of the velocity profile are performable by the autonomous vehicle at a target time based on the initial state of the autonomous vehicle, the acceleration limit, the one or more steering limits, and the characteristics of the one or more roads.

In some implementations, the range of lateral offsets of the lateral profile are performable by the autonomous vehicle at a target distance based on the initial state of the autonomous vehicle, the acceleration limit, the one or more steering limits, and the characteristics of the one or more roads.

In some implementations, the one or more steering limits include at least one of a steering angle limit or a steering angle rate limit. In some implementations, the initial state of the autonomous vehicle includes an initial velocity and an initial acceleration of the autonomous vehicle. In some implementations, the operations include determining a jerk range based on the vehicle state data and the platform limit data. In some implementations, the jerk range is descriptive indicative of a maximum jerk and a minimum jerk based on the steering angle rate limit, the initial velocity, and the initial acceleration.

In an aspect, the present disclosure provides for one or more example non-transitory computer-readable media storing instructions that are executable by one or more processors to cause an autonomous vehicle control system to perform operations. The operations include obtaining road data, vehicle state data, and platform limit data associated with an autonomous vehicle. The road data is indicative of one or more characteristics of one or more roads within an environment of the autonomous vehicle. The vehicle state data is indicative of a state of the autonomous vehicle. The platform limit data is indicative of an acceleration limit and one or more steering limits of the autonomous vehicle. The operations include generating a velocity profile and a lateral profile associated with the autonomous vehicle based on the road data, vehicle state data, and platform limit data. The velocity profile indicates a range of velocities performable by the autonomous vehicle based on the state of the autonomous vehicle and the acceleration limit. The lateral profile indicates a range of lateral offsets from a path of the autonomous vehicle that are performable by the autonomous vehicle based on the state of the autonomous vehicle and the one or more steering limits. The operations include generating a plurality of initial candidate trajectories for the autonomous vehicle based on the velocity profile and the lateral profile. The plurality of initial candidate trajectories are feasible for execution by the autonomous vehicle based on dynamic limits associated with velocities and lateral movement described in the velocity profile and the lateral profile. The operations include determining, from among the plurality of initial candidate trajectories, a selected trajectory for the autonomous vehicle. The operations include providing one or more instructions to control a motion of the autonomous vehicle in accordance with the selected trajectory.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example operational scenario, according to some implementations of the present disclosure;

FIG. 2 is a block diagram of an example system, according to some implementations of the present disclosure;

FIG. 3A is a representation of an example operational environment, according to some implementations of the present disclosure;

FIG. 3B is a representation of an example map of an operational environment, according to some implementations of the present disclosure;

FIG. 3C is a representation of an example operational environment, according to some implementations of the present disclosure;

FIG. 3D is a representation of an example map of an operational environment, according to some implementations of the present disclosure;

FIG. 4 is a block diagram of an example parameter-based sampling system, according to some implementations of the present disclosure;

FIG. 5 is a block diagram of an example data flow pipeline for trajectory generation based on determined profiles, according to some implementations of the present disclosure;

FIG. 6 is a representation of an example spatial path, according to some implementations of the present disclosure;

FIG. 7 is a representation of an example plot of maximum velocity change, according to some implementations of the present disclosure;

FIG. 8 is a representation of an example plot of maximum and minimum values of attainable speed deltas, according to some implementations of the present disclosure;

FIG. 9 is a representation of an example plot of velocity profiles based on minimum and maximum parameters, according to some implementations of the present disclosure;

FIG. 10 is a representation of an example plot of lateral profiles, according to some implementations of the present disclosure;

FIG. 11 is a representation of an example plot of maximum and minimum offsets for a lateral profile, according to some implementations of the present disclosure;

FIG. 12A is a representation of a first example basis path plot, according to some implementations of the present disclosure;

FIG. 12B is a representation of a second example basis path plot, according to some implementations of the present disclosure;

FIG. 12C is a representation of a third example basis path plot, according to some implementations of the present disclosure;

FIG. 13 is a flowchart of an example method for controlling an autonomous vehicle, according to some implementations of the present disclosure;

FIG. 14 is a flowchart of an example method for generating a velocity profile, according to some implementations of the present disclosure;

FIG. 15 is a flowchart of an example method for generating platform limit data based on vehicle identifiers, according to some implementations of the present disclosure;

FIG. 16 is a flowchart of an example method for generating platform limit data based on load data, according to some implementations of the present disclosure;

FIG. 17 is a flowchart of an example method for generating road data, according to some implementations of the present disclosure;

FIG. 18 is a flowchart of an example method for generating initial candidate trajectories, according to some implementations of the present disclosure;

FIG. 19 is a flowchart of an example method for training and validating a machine-learned operational system, according to some implementations of the present disclosure;

FIG. 20 is a block diagram of an example validation system, according to some implementations of the present disclosure;

FIG. 21 is a block diagram of an example auditing system, according to some implementations of the present disclosure; and

FIG. 22 is a block diagram of an example computing system for performing system validation, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and can be implemented for or within other autonomous platforms and other computing systems.

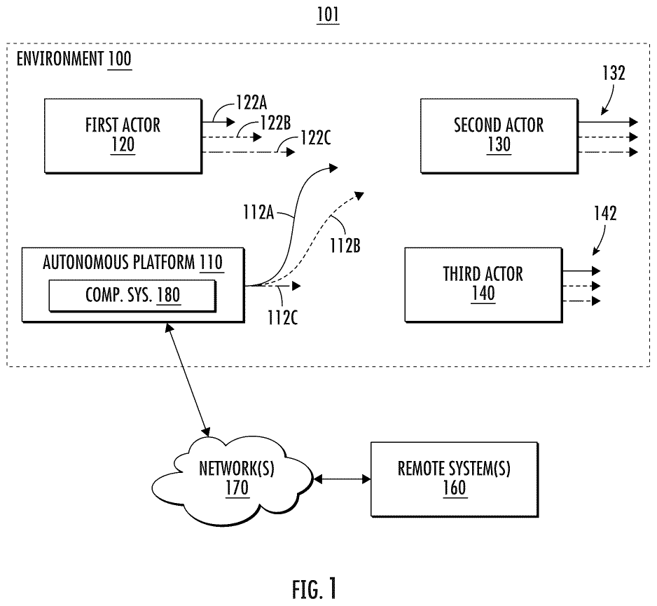

With reference to FIGS. 1-22, example embodiments of the present disclosure are discussed in further detail. FIG. 1 is a block diagram 101 of an example operational scenario according to example implementations of the present disclosure. In the example operational scenario, an environment 100 contains an autonomous platform 110 and a number of objects, including first actor 120, second actor 130, and third actor 140. In the example operational scenario, the autonomous platform 110 may move through the environment 100 and interact with the object(s) that are located within the environment 100 (e.g., first actor 120, second actor 130, third actor 140). The autonomous platform 110 may optionally be configured to communicate with remote system(s) 160 through network(s) 170.

The environment 100 may be or include an indoor environment (e.g., within one or more facilities.) or an outdoor environment. An indoor environment, for example, may be an environment enclosed by a structure such as a building (e.g., a service depot, maintenance location, manufacturing facility). An outdoor environment, for example, may be one or more areas in the outside world such as, for example, one or more rural areas (e.g., with one or more rural travel ways), one or more urban areas (e.g., with one or more city travel ways, highways), one or more suburban areas (e.g., with one or more suburban travel ways), or other outdoor environments.

The autonomous platform 110 may be any type of platform configured to operate within the environment 100. For example, the autonomous platform 110 may be a vehicle configured to autonomously perceive and operate within the environment 100. The vehicles may be a ground-based autonomous vehicle such as, for example, an autonomous car, truck, van, or other vehicle type. The autonomous platform 110 may be an autonomous vehicle that may control, be connected to, or be otherwise associated with implements, attachments, or accessories for transporting people or cargo. This may include, for example, an autonomous tractor optionally coupled to a cargo trailer. Additionally or alternatively, the autonomous platform 110 may be any other type of vehicle such as one or more aerial vehicles, water-based vehicles, space-based vehicles, or other ground-based vehicles.

The autonomous platform 110 may be configured to communicate with the remote system(s) 160. For instance, the remote system(s) 160 may communicate with the autonomous platform 110 for assistance (e.g., navigation assistance, situation response assistance), control (e.g., fleet management, remote operation), maintenance (e.g., updates, monitoring), or other local or remote tasks. In some implementations, the remote system(s) 160 may provide data indicating tasks that the autonomous platform 110 should perform. For example, as further described herein, the remote system(s) 160 may provide data indicating that the autonomous platform 110 is to perform a trip/service such as a user transportation trip/service, delivery trip/service (e.g., for cargo, freight, items), or other service.

The autonomous platform 110 may communicate with the remote system(s) 160 using the network(s) 170. The network(s) 170 may facilitate the transmission of signals (e.g., electronic signals) or data (e.g., data from a computing device) and may include any combination of various wired (e.g., twisted pair cable) or wireless communication mechanisms (e.g., cellular, wireless, satellite, microwave, radio frequency) or any desired network topology (or topologies). For example, the network(s) 170 may include a local area network (e.g., intranet), a wide area network (e.g., the Internet), a wireless LAN network (e.g., through Wi-Fi), a cellular network, a SATCOM network, a VHF network, a HF network, a WiMAX based network, or any other suitable communications network (or combination thereof) for transmitting data to or from the autonomous platform 110.

As shown for example in FIG. 1, the environment 100 may include one or more objects. The object(s) may be objects not in motion or not predicted to move (“static objects”) or object(s) in motion or predicted to be in motion (“dynamic objects” or “actors”). In some implementations, the environment 100 may include any number of actor(s) such as, for example, one or more pedestrians, animals, vehicles, trailers, or other actor types. An object may include one or more portions. For example, a truck including a tractor pulling a trailer may be identified as a single object, with multiple portions: a first portion (e.g., tractor) and a second portion (e.g., trailer). In some implementations, the portions may be identified as separate objects. For example, a tractor may be identified as a first object and a trailer (being pulled by the tractor) may be identified as a separate, second object. In another example, an open door of a vehicle may be identified as a separate object from the vehicle or as an extension of the vehicle, as further described herein.

The actor(s) may move within the environment according to one or more actor trajectories. For instance, the first actor 120 may move along any one of the first actor trajectories 122A-C, the second actor 130 may move along any one of the second actor trajectories 132, and the third actor 140 may move along any one of the third actor trajectories 142. In an embodiment, the actor(s) may include extensions which extend from the main volume of the object. These extensions may be considered as the autonomous platform 110 traverses the environment 100.

As further described herein, the autonomous platform 110 may utilize its autonomy system(s) to detect these actors (and their movement), their extensions, and plan its motion to navigate through the environment 100 according to one or more platform trajectories 112A-C. The autonomous platform 110 may include onboard computing system(s) 180. The onboard computing system(s) 180 may include one or more processors and one or more memory devices. The one or more memory devices may store instructions executable by the one or more processors to cause the one or more processors to perform operations or functions associated with the autonomous platform 110, including implementing its autonomy system(s).

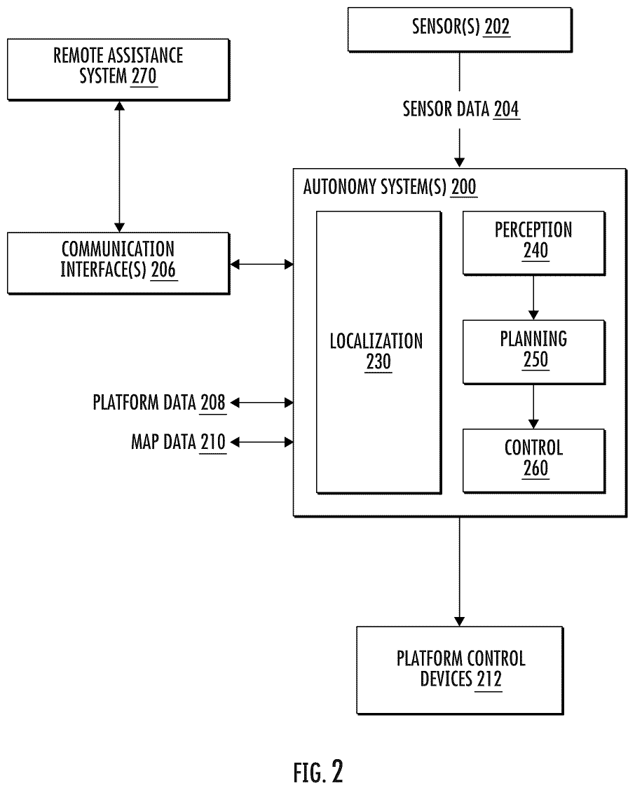

FIG. 2 is a block diagram 201 of an example autonomy system 200 for an autonomous platform, according to some implementations of the present disclosure. In some implementations, the autonomy system 200 may be implemented by a computing system of the autonomous platform (e.g., the onboard computing system(s) 180 of the autonomous platform 110). The autonomy system 200 may operate to obtain inputs from sensor(s) 202 or other input devices. In some implementations, the autonomy system 200 may additionally obtain platform data 208 (e.g., map data 210) from local or remote storage. The autonomy system 200 may generate control outputs for controlling the autonomous platform (e.g., through platform control devices 212) based on sensor data 204, map data 210, or other data.

The autonomy system 200 may include different subsystems for performing various autonomy operations. The subsystems may include a localization system 230, a perception system 240, a planning system 250, and a control system 260. The localization system 230 may determine the location of the autonomous platform within its environment; the perception system 240 may detect, classify, and track objects in the environment; the planning system 250 may determine a trajectory for the autonomous platform; and the control system 260 may translate the trajectory into vehicle controls for controlling the autonomous platform. The autonomy system 200 may be implemented by one or more onboard computing system(s). The subsystems may include one or more processors and one or more memory devices. The one or more memory devices may store instructions executable by the one or more processors to cause the one or more processors to perform operations or functions associated with the subsystems. The computing resources of the autonomy system 200 may be shared among its subsystems, or a subsystem may have a set of dedicated computing resources.

In some implementations, the autonomy system 200 may be implemented for or by an autonomous vehicle (e.g., a ground-based autonomous vehicle). The autonomy system 200 may perform various processing techniques on inputs (e.g., the sensor data 204, the map data 210) to perceive and understand the vehicle's surrounding environment and generate an appropriate set of control outputs to implement a vehicle motion plan (e.g., including one or more trajectories) for traversing the vehicle's surrounding environment (e.g., environment 100 of FIG. 1). In some implementations, an autonomous vehicle implementing the autonomy system 200 may drive, navigate, or operate, with minimal or no interaction from a human operator (e.g., driver, pilot).

In some implementations, the autonomous platform may be configured to operate in a plurality of operating modes. For instance, the autonomous platform may be configured to operate in a fully autonomous operating mode in which the autonomous platform is controllable without user input (e.g., may drive and navigate with no input from a human operator present in the autonomous vehicle or remote from the autonomous vehicle). The autonomous platform may operate in a semi-autonomous operating mode in which the autonomous platform may operate with some input from a human operator present in the autonomous platform (or a human operator that is remote from the autonomous platform). In some implementations, the autonomous platform may enter into a manual operating mode in which the autonomous platform is fully controllable by a human operator (e.g., human driver) and may be prohibited or disabled (e.g., temporary, permanently) from performing autonomous navigation (e.g., autonomous driving). The autonomous platform may be configured to operate in other modes such as, for example, park or sleep modes (e.g., for use between tasks such as waiting to provide a trip/service, recharging). In some implementations, the autonomous platform may implement vehicle operating assistance technology (e.g., collision mitigation system, power assist steering), for example, to help assist the human operator of the autonomous platform (e.g., while in a manual mode).

The autonomy system 200 may be located onboard (e.g., on or within) an autonomous platform and may be configured to operate the autonomous platform in various environments. The environment may be a real-world environment or a simulated environment. In some implementations, one or more simulation computing devices may simulate one or more of: the sensors 202, the sensor data 204, communication interface(s) 206, the platform data 208, or the platform control devices 212 for simulating operation of the autonomy system 200.

In some implementations, the autonomy system 200 may communicate with one or more networks or other systems with the communication interface(s) 206. The communication interface(s) 206 may include any suitable components for interfacing with one or more network(s) (e.g., the network(s) 170 of FIG. 1), including, for example, transmitters, receivers, ports, controllers, antennas, or other suitable components that may help facilitate communication. In some implementations, the communication interface(s) 206 may include a plurality of components (e.g., antennas, transmitters, receivers) that allow it to implement and utilize various communication techniques (e.g., multiple-input, multiple-output (MIMO) technology).

In some implementations, the autonomy system 200 may use the communication interface(s) 206 to communicate with one or more computing devices that are remote from the autonomous platform (e.g., the remote system(s) 160) over one or more network(s) (e.g., the network(s) 170). For instance, in some examples, one or more inputs, data, or functionalities of the autonomy system 200 may be supplemented or substituted by a remote system communicating over the communication interface(s) 206. For instance, in some implementations, the map data 210 may be downloaded over a network to a remote system using the communication interface(s) 206. In some examples, one or more of the localization system 230, the perception system 240, the planning system 250, or the control system 260 may be updated, influenced, nudged, or communicated with, by a remote system for assistance, maintenance, situational response override, management, or other purposes.

The sensor(s) 202 may be located onboard the autonomous platform. In some implementations, the sensor(s) 202 may include one or more types of sensor(s). For instance, one or more sensors may include image capturing device(s) (e.g., visible spectrum cameras, infrared cameras). Additionally or alternatively, the sensor(s) 202 may include one or more depth capturing device(s). For example, the sensor(s) 202 may include one or more Light Detection and Ranging (LIDAR) sensor(s) or Radio Detection and Ranging (RADAR) sensor(s). The sensor(s) 202 may be configured to generate point data descriptive of at least a portion of a three-hundred-and-sixty-degree view of the surrounding environment. The point data may be point cloud data (e.g., three-dimensional LIDAR point cloud data, RADAR point cloud data). In some implementations, one or more of the sensor(s) 202 for capturing depth information may be fixed to a rotational device in order to rotate the sensor(s) 202 about an axis. The sensor(s) 202 may be rotated about the axis while capturing data in interval sector packets descriptive of different portions of a three-hundred-and-sixty-degree view of a surrounding environment of the autonomous platform. In some implementations, one or more of the sensor(s) 202 for capturing depth information may be solid state.

The sensor(s) 202 may be configured to capture the sensor data 204 indicating or otherwise being associated with at least a portion of the environment of the autonomous platform. The sensor data 204 may include image data (e.g., 2D camera data, video data), RADAR data, LIDAR data (e.g., 3D point cloud data), audio data, or other types of data. In some implementations, the autonomy system 200 may obtain input from additional types of sensors, such as inertial measurement units (IMUs), altimeters, inclinometers, odometry devices, location or positioning devices (e.g., GPS, compass), wheel encoders, or other types of sensors. In some implementations, the autonomy system 200 may obtain sensor data 204 associated with particular component(s) or system(s) of an autonomous platform. This sensor data 204 may indicate, for example, wheel speed, component temperatures, steering angle, cargo or passenger status. In some implementations, the autonomy system 200 may obtain sensor data 204 associated with ambient conditions, such as environmental or weather conditions. In some implementations, the sensor data 204 may include multi-modal sensor data. The multi-modal sensor data may be obtained by at least two different types of sensor(s) (e.g., of the sensors 202) and may indicate static object(s) within an environment of the autonomous platform. The multi-modal sensor data may include at least two types of sensor data (e.g., camera and LIDAR data). In some implementations, the autonomous platform may utilize the sensor data 204 for sensors that are remote from (e.g., offboard) the autonomous platform. This may include, for example, sensor data 204 captured by a different autonomous platform.

The autonomy system 200 may obtain the map data 210 associated with an environment in which the autonomous platform was, is, or will be located. The map data 210 may provide information about an environment or a geographic area. For example, the map data 210 may provide information regarding the identity and location of different travel ways (e.g., roadways), travel way segments (e.g., road segments), buildings, or other items or objects (e.g., lampposts, crosswalks, curbs); the location and directions of boundaries or boundary markings (e.g., the location and direction of traffic lanes, parking lanes, turning lanes, bicycle lanes, other lanes); traffic control data (e.g., the location and instructions of signage, traffic lights, other traffic control devices); obstruction information (e.g., temporary or permanent blockages); event data (e.g., road closures/traffic rule alterations due to parades, concerts, sporting events); nominal vehicle path data (e.g., indicating an ideal vehicle path such as along the center of a certain lane); or any other map data that provides information that assists an autonomous platform in understanding its surrounding environment and its relationship thereto. In some implementations, the map data 210 may include high-definition map information. Additionally or alternatively, the map data 210 may include sparse map data (e.g., lane graphs). In some implementations, the sensor data 204 may be fused with or used to update the map data 210 in online or offline.

The autonomy system 200 may include the localization system 230, which may provide an autonomous platform with an understanding of its location and orientation in an environment. In some examples, the localization system 230 may support one or more other subsystems of the autonomy system 200, such as by providing a unified local reference frame for performing, e.g., perception operations, planning operations, or control operations.

In some implementations, the localization system 230 may determine a current position of the autonomous platform. A current position may include a global position (e.g., respecting a georeferenced anchor) or relative position (e.g., respecting objects in the environment). The localization system 230 may generally include or interface with any device or circuitry for analyzing a position or change in position of an autonomous platform (e.g., autonomous ground-based vehicle). For example, the localization system 230 may determine position by using one or more of: inertial sensors (e.g., inertial measurement unit(s)), a satellite positioning system, radio receivers, networking devices (e.g., based on IP address), triangulation or proximity to network access points or other network components (e.g., cellular towers, Wi-Fi access points), or other suitable techniques. The position of the autonomous platform may be used by various subsystems of the autonomy system 200 or provided to a remote computing system (e.g., using the communication interface(s) 206).

In some implementations, the localization system 230 may register relative positions of elements of a surrounding environment of an autonomous platform with recorded positions in the map data 210. For instance, the localization system 230 may process the sensor data 204 (e.g., LIDAR data, RADAR data, camera data) for aligning or otherwise registering to a map of the surrounding environment (e.g., from the map data 210) to understand the position of the autonomous platform 110 within that environment. Accordingly, in some implementations, the autonomous platform 110 may identify its position within the surrounding environment (e.g., across six axes) based on a search over the map data 210. In some implementations, given an initial location, the localization system 230 may update the location of the autonomous platform 110 with incremental re-alignment based on recorded or estimated deviations from the initial location. In some implementations, a position may be registered within the map data 210.

The map data 210 may include a large volume of data subdivided into geographic tiles, such that a desired region of a map stored in the map data 210 may be reconstructed from one or more tiles. For instance, a plurality of tiles selected from the map data 210 may be stitched together by the autonomy system 200 based on a position obtained by the localization system 230 (e.g., a number of tiles selected in the vicinity of the position).

In some implementations, the localization system 230 may determine positions (e.g., relative or absolute) of one or more attachments or accessories for an autonomous platform 110. For instance, an autonomous platform 110 may be associated with a cargo platform, and the localization system 230 may provide positions of one or more points on the cargo platform. For example, a cargo platform may include a trailer or other device towed or otherwise attached to or manipulated by an autonomous platform 110, and the localization system 230 may provide for data describing the position (e.g., absolute, relative) of the autonomous platform 110 as well as the cargo platform. Such information may be obtained by the other autonomy systems to help operate the autonomous platform 110.

The autonomy system 200 may include the perception system 240, which may allow an autonomous platform 110 to detect, classify, and track objects in the environment of the autonomous platform 110. Environmental features or objects perceived within an environment may be those within the field of view of the sensor(s) 202 or predicted to be occluded from the sensor(s) 202. This may include object(s) not in motion or not predicted to move (static objects) or object(s) in motion or predicted to be in motion (dynamic objects/actors). In an embodiment, this may include extensions of static object(s) or dynamic objects/actors.

The perception system 240 may determine one or more states (e.g., current or past state(s)) of one or more objects that are within a surrounding environment of an autonomous platform. For example, state(s) may describe (e.g., for a given time, time period) an estimate of an object's current or past location (also referred to as position); current or past speed/velocity; current or past acceleration; current or past heading; current or past orientation; size/footprint (e.g., as represented by a bounding shape, object highlighting); classification (e.g., pedestrian class vs. vehicle class vs. bicycle class); the uncertainties associated therewith; other state information; or any combination thereof. In some implementations, the perception system 240 may determine the state(s) using one or more algorithms or machine-learned models configured to identify/classify objects based on inputs from the sensor(s) 202. The perception system may use different modalities of the sensor data 204 to generate a representation of the environment to be processed by the one or more algorithms or machine-learned models. In some implementations, state(s) for one or more identified or unidentified objects may be maintained and updated over time as the autonomous platform continues to perceive or interact with the objects (e.g., maneuver with or around, yield to). In this manner, the perception system 240 may provide an understanding about a current state of an environment (e.g., including the objects therein) informed by a record of prior states of the environment (e.g., including movement histories for the objects therein). Such information may be helpful as the autonomous platform plans its motion through the environment.

The autonomy system 200 may include the planning system 250, which may be configured to determine how the autonomous platform 110 is to interact with and move within its environment. The planning system 250 may determine one or more motion plans for an autonomous platform. A motion plan may include one or more trajectories (e.g., motion trajectories) that indicate a path for an autonomous platform to follow. A trajectory may be of a certain length or time range. The length or time range may be defined by the planning system 250. A motion trajectory may be defined by one or more waypoints (with associated coordinates). The waypoint(s) may be future location(s) for the autonomous platform. The motion plans may be continuously generated, updated, and considered by the planning system 250.

The motion planning system 250 may determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of interfering with another object.

The planning system 250 may determine a desired trajectory for executing a strategy. For instance, the planning system 250 may obtain one or more trajectories for executing one or more strategies. The planning system 250 may evaluate trajectories or strategies (e.g., with scores, costs, rewards, constraints) and rank them. For instance, the planning system 250 may use forecasting output(s) that indicate interactions (e.g., proximity, intersections) between trajectories for the autonomous platform and one or more objects to inform the evaluation of candidate trajectories or strategies for the autonomous platform. In some implementations, the planning system 250 may utilize static cost(s) to evaluate trajectories for the autonomous platform (e.g., “avoid lane boundaries,” “minimize jerk,”). Additionally or alternatively, the planning system 250 may utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform). The planning system 250 may rank trajectories based on one or more static costs, one or more dynamic costs, or a combination thereof. The planning system 250 may select a motion plan (and a corresponding trajectory) based on a ranking of a plurality of candidate trajectories. In some implementations, the planning system 250 may select a highest ranked candidate, or a highest ranked feasible candidate.

The planning system 250 may then validate the selected trajectory against one or more constraints before the trajectory is executed by the autonomous platform 110.

To help with its motion planning decisions, the planning system 250 may be configured to perform a forecasting function. The planning system 250 may forecast future state(s) of the environment. This may include forecasting the future state(s) of other actors in the environment. In some implementations, the planning system 250 may forecast future state(s) based on current or past state(s) (e.g., as developed or maintained by the perception system 240). In some implementations, future state(s) may be or include one or more forecasted trajectories (e.g., positions over time) of the objects in the environment, such as other actors. In some implementations, one or more of the future state(s) may include one or more probabilities associated therewith (e.g., marginal probabilities, conditional probabilities). For example, the one or more probabilities may include one or more probabilities conditioned on the strategy or trajectory options available to the autonomous platform 110. Additionally or alternatively, the probabilities may include probabilities conditioned on trajectory options available to one or more other actors.

In some implementations, the planning system 250 may perform interactive forecasting. The planning system 250 may determine a motion plan for an autonomous platform 110 with an understanding of how forecasted future states of the environment 100 may be affected by execution of one or more candidate motion plans.

By way of example, with reference again to FIG. 1, the autonomous platform 110 may determine candidate motion plans corresponding to a set of platform trajectories 112A-C that respectively correspond to the first actor trajectories 122A-C for the first actor 120, trajectories 132 for the second actor 130, and trajectories 142 for the third actor 140 (e.g., with respective trajectory correspondence indicated with matching line styles). For instance, the autonomous platform 110 (e.g., using its autonomy system 200) may forecast that a platform trajectory 112A to more quickly move the autonomous platform 110 into the area in front of the first actor 120 is likely associated with the first actor 120 decreasing forward speed and yielding more quickly to the autonomous platform 110 in accordance with first actor trajectory 122A. Additionally or alternatively, the autonomous platform 110 may forecast that a platform trajectory 112B to gently move the autonomous platform 110 into the area in front of the first actor 120 is likely associated with the first actor 120 slightly decreasing speed and yielding slowly to the autonomous platform 110 in accordance with first actor trajectory 122B. Additionally or alternatively, the autonomous platform 110 may forecast that a platform trajectory 112C to remain in a parallel alignment with the first actor 120 is likely associated with the first actor 120 not yielding any distance to the autonomous platform 110 in accordance with first actor trajectory 122C. Based on comparison of the forecasted scenarios to a set of desired outcomes (e.g., by scoring scenarios based on a cost or reward), the planning system 250 may select a motion plan (and its associated trajectory) in view of the autonomous platform's interaction with the environment 100. In this manner, for example, the autonomous platform 110 may achieve at least a technical improvement that interleaves its forecasting and motion planning functionality.

To implement selected motion plan(s), the autonomy system 200 may include a control system 260 (e.g., a vehicle control system). Generally, the control system 260 may provide an interface between the autonomy system 200 and the platform control devices 212 for implementing the strategies and motion plan(s) generated by the planning system 250. For instance, the control system 260 may implement the selected motion plan/trajectory to control motion of the autonomous platform 110 through its environment 100 by following the selected trajectory (e.g., the waypoints included therein). The control system 260 may, for example, translate a motion plan into instructions for the appropriate platform control devices 212 (e.g., acceleration control, brake control, steering control). By way of example, the control system 260 may translate a selected motion plan into instructions to adjust a steering component (e.g., a steering angle) by a certain number of degrees, apply a certain magnitude of braking force, increase/decrease speed, or implement other motion controls. In some implementations, the control system 260 may communicate with the platform control devices 212 through communication channels including, for example, one or more data buses (e.g., controller area network (CAN)), onboard diagnostics connectors (e.g., OBD-II), or a combination of wired or wireless communication links. The platform control devices 212 may send or obtain data, messages, signals (or other types of communication) to or from the autonomy system 200 (or vice versa) through the communication channel(s).

The autonomy system 200 may receive, through communication interface(s) 206, assistive signal(s) from remote assistance system 270. Remote assistance system 270 may communicate with the autonomy system 200 over a network (e.g., as a remote system 160 over network 170). In some implementations, the autonomy system 200 may initiate a communication session with the remote assistance system 270. For example, the autonomy system 200 may initiate a session based on or in response to a trigger. In some implementations, the trigger may be an alert, an error signal, a map feature, a request, a location, a traffic condition, a road condition, or other trigger.

After initiating the session, the autonomy system 200 may provide context data to the remote assistance system 270. The context data may include sensor data 204 and state data of the autonomous platform. For example, the context data may include a live camera feed from a camera of the autonomous platform and a current speed of the autonomous platform 110. An operator (e.g., human operator) of the remote assistance system 270 may use the context data to select one or more assistive signals. The assistive signal(s) may provide values or adjustments for various operational parameters or characteristics for the autonomy system 200. For instance, the assistive signal(s) may include way points (e.g., a path around an obstacle, lane change), velocity or acceleration profiles (e.g., speed limits), relative motion instructions (e.g., convoy formation), operational characteristics (e.g., use of auxiliary systems, reduced energy processing modes), or other signals to assist the autonomy system 200.

The autonomy system 200 may use the assistive signal(s) for input into one or more autonomy subsystems for performing autonomy functions. For instance, the planning subsystem 250 may receive the assistive signal(s) as an input for generating a motion plan. For example, assistive signal(s) may include constraints for generating a motion plan. Additionally or alternatively, assistive signal(s) may include cost or reward adjustments for influencing motion planning by the planning subsystem 250. Additionally or alternatively, assistive signal(s) may be considered by the autonomy system 200 as suggestive inputs for consideration in addition to other received data (e.g., sensor inputs).

The autonomy system 200 may be platform agnostic, and the control system 260 may provide control instructions to platform control devices 212 for a variety of different platforms for autonomous movement (e.g., a plurality of different autonomous platforms fitted with autonomous control systems). This may include a variety of different types of autonomous vehicles (e.g., sedans, vans, SUVs, trucks, electric vehicles, combustion power vehicles) from a variety of different manufacturers/developers that operate in various different environments and, in some implementations, perform one or more vehicle services.

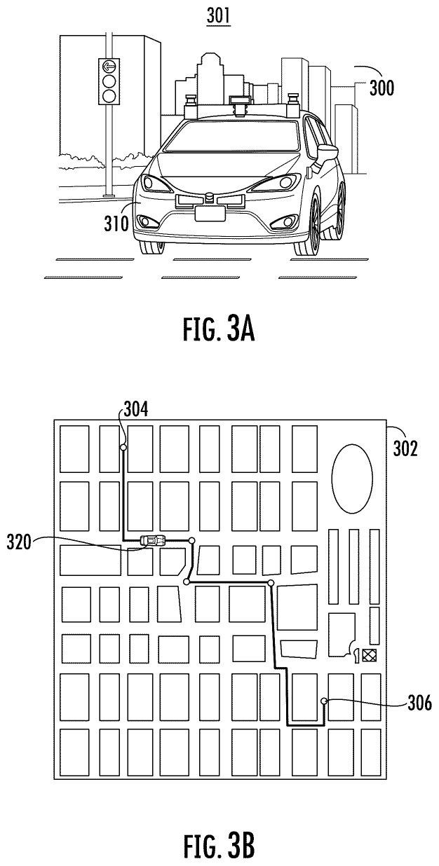

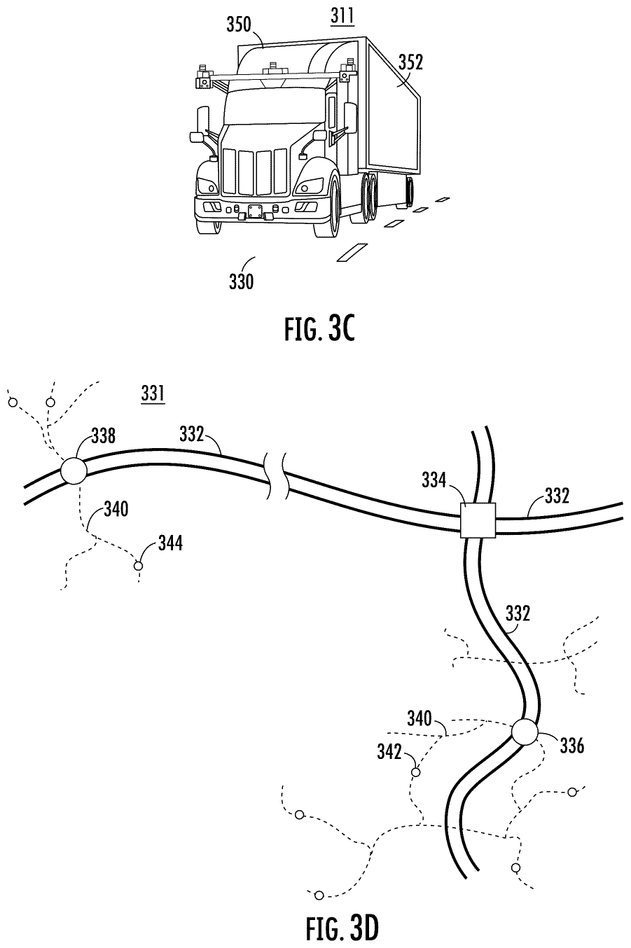

For example, with reference to FIG. 3A, an operational environment 301 may include a dense environment 300. An autonomous platform may include an autonomous vehicle 310 controlled by the autonomy system 200. In some implementations, the autonomous vehicle 310 may be configured for maneuverability in a dense environment, such as with a configured wheelbase or other specifications. In some implementations, the autonomous vehicle 310 may be configured for transporting cargo or passengers. In some implementations, the autonomous vehicle 310 may be configured to transport numerous passengers (e.g., a passenger van, a shuttle, a bus). In some implementations, the autonomous vehicle 310 may be configured to transport cargo, such as large quantities of cargo (e.g., a truck, a box van, a step van) or smaller cargo (e.g., food, personal packages).

With reference to FIG. 3B, a selected overhead view 302 of the dense environment 300 is shown overlaid with an example trip/service between a first location 304 and a second location 306. The example trip/service may be assigned, for example, to an autonomous vehicle 320 by a remote computing system. The autonomous vehicle 320 may be, for example, the same type of vehicle as autonomous vehicle 310. The example trip/service may include transporting passengers or cargo between the first location 304 and the second location 306. In some implementations, the example trip/service may include travel to or through one or more intermediate locations, such as to onload or offload passengers or cargo. In some implementations, the example trip/service may be prescheduled (e.g., for regular traversal, such as on a transportation schedule). In some implementations, the example trip/service may be on-demand (e.g., as requested by or for performing a taxi, rideshare, ride hailing, courier, delivery service).

With reference to FIG. 3C, in another example, an operational environment 311 may include an open travel way environment 330. An autonomous platform may include an autonomous vehicle 350 controlled by the autonomy system 200. This may include an autonomous tractor for an autonomous truck. In some implementations, the autonomous vehicle 350 may be configured for high payload transport (e.g., transporting freight or other cargo or passengers in quantity), such as for long distance, high payload transport. For instance, the autonomous vehicle 350 may include one or more cargo platform attachments such as a trailer 352. Although depicted as a towed attachment in FIG. 3C, in some implementations one or more cargo platforms may be integrated into (e.g., attached to the chassis of) the autonomous vehicle 350 (e.g., as in a box van, step van).

With reference to FIG. 3D, a selected overhead view 331 of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) may be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service may be assigned by a remote computing system. In some implementations, the transfer hub 336 may be an origin point for cargo (e.g., a depot, a warehouse, a facility) and the transfer hub 338 may be a destination point for cargo (e.g., a retailer). However, in some implementations, the transfer hub 336 may be an intermediate point along a cargo item's ultimate journey between its respective origin and its respective destination. For instance, a cargo item's origin may be situated along the access travel ways 340 at the location 342. The cargo item may accordingly be transported to the transfer hub 336 (e.g., by a human-driven vehicle, by the autonomous vehicle 310) for staging. At the transfer hub 336, various cargo items may be grouped or staged for longer distance transport over the travel ways 332.

In some implementations of an example trip/service, a group of staged cargo items may be loaded onto an autonomous vehicle (e.g., the autonomous vehicle 350) for transport to one or more other transfer hubs, such as the transfer hub 338. For instance, although not depicted, it is to be understood that the open travel way environment 330 may include more transfer hubs than the transfer hubs 336 and 338, and may include more travel ways 332 interconnected by more interchanges 334. A simplified map is presented here for purposes of clarity only. In some implementations, one or more cargo items transported to the transfer hub 338 may be distributed to one or more local destinations (e.g., by a human-driven vehicle, by the autonomous vehicle 310), such as along the access travel ways 340 to the location 344. In some implementations, the example trip/service may be prescheduled (e.g., for regular traversal, such as on a transportation schedule). In some implementations, the example trip/service may be on-demand (e.g., as requested by or for performing a chartered passenger transport or freight delivery service).

To help improve the performance of an autonomous platform, such as an autonomous vehicle controlled at least in part using autonomy system(s) 200 (e.g., the autonomous vehicles 310 or 350), the technology of the present disclosure can be leveraged to determine a velocity profile and a lateral profile that can be utilized to parameterize the initial candidate trajectory generation (or sampling) for improved autonomous motion control.

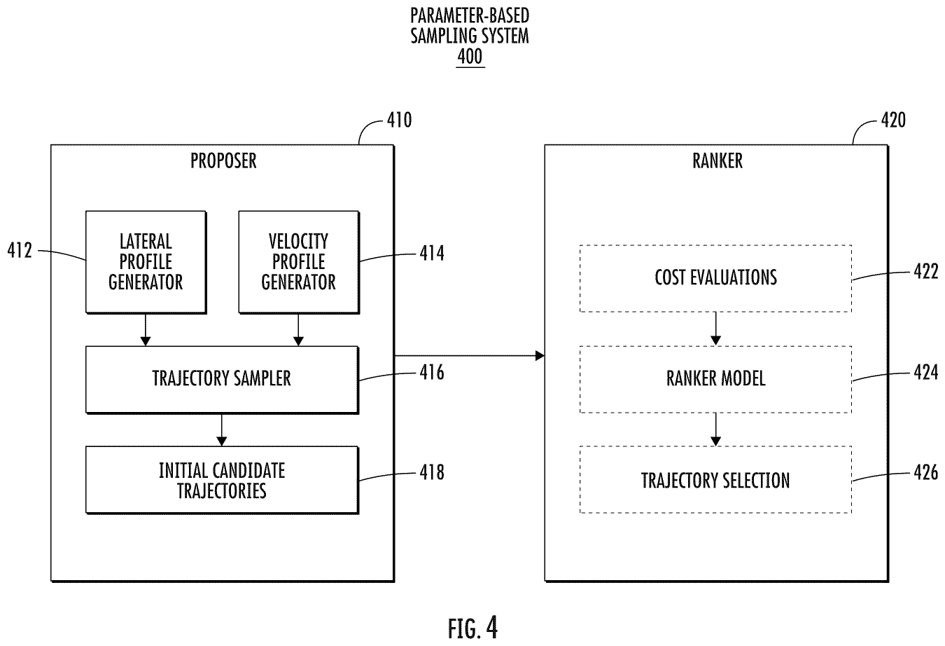

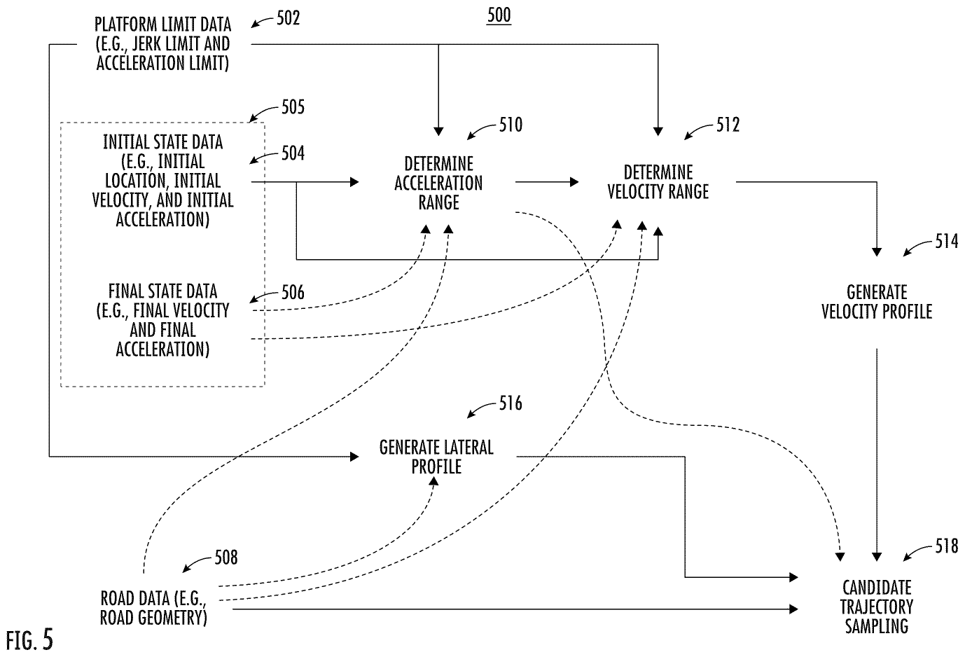

FIG. 4 is a block diagram of an example parameter-based sampling system 400, according to some implementations of the present disclosure. FIG. 5 is a block diagram of an example data flow pipeline 500 for trajectory generation based on determined profiles, according to some implementations of the present disclosure. The following description provides an overview of the components of the parameter-based sample system 400 and the functionality thereof, also with reference to FIG. 5. Further example implementations of the operations performed by the components is provided thereafter.

The parameter-based sampling system 400 can include a proposer system 410 (a “trajectory proposer”) and a ranker system 420 (a “trajectory ranker”). The proposer system 410 can be configured to generate a plurality of initial candidate trajectories 418. The ranker system 420 can evaluate the plurality of initial candidate trajectories 418 to perform a trajectory selection 426.

For example, the parameter-based sampling system 400 can obtain road data 508, vehicle state data 505, or platform limit data 502 (shown in FIG. 5). As described herein, the road data 508 can be indicative of one or more characteristics of one or more roads within an environment of the autonomous vehicle. In some implementations, the one or more characteristics can include the gradient of the road, the curves of the road, stop lights, stop signs, speed limits, historical traffic data, number of lanes, presences of a shoulder, the lines, or other characteristics. The one or more roads can include a road associated with the initial location of the autonomous vehicle during a time horizon of a trajectory prediction (e.g., a current location during a current time horizon). Additionally or alternatively, the one or more roads can include one or more roads proximate to, or associated with, a current road or the autonomous vehicle, which may include one or more roads on a navigation route. In an example, the road data 508 can be based on route data or map data and can indicate an angle of curvature or change in elevation of an upcoming segment of road that the autonomous vehicle will travel.

The vehicle state data 505 can be indicative of a state of the autonomous vehicle. In some implementations, the vehicle state data 505 may be indicative of an initial state of the autonomous vehicle during a trajectory prediction time horizon. The initial state of the autonomous vehicle can include an initial velocity and an initial acceleration of the autonomous vehicle. The initial velocity and the initial acceleration can include the current velocity and acceleration of the vehicle (e.g., at a t0).

The platform limit data can be indicative of an acceleration limit and one or more steering limits of the autonomous vehicle. In some implementations, the one or more steering limits can include at least one of a steering angle limit or a steering angle rate limit. The platform limit data may be determined based on vehicle capabilities, cargo load, weight distribution, regulations, laws, vehicle safety terms, or other data.

The system 400 can determine the platform limit data, for example, based on obtaining engine information and cargo load information for the autonomous vehicle. The engine information can describe the horse power, type of fuel utilized, number of cylinders, size of the cylinders, or torque of the engine. The cargo load information can describe a total weight of the cargo, itemized weights of the cargo, locations of the cargo, density of the cargo, or weight distribution of the cargo. The system 400 can determine the platform limit data 502 based on the dynamic limits of the autonomous vehicle based on the engine information and cargo load information. For example, vehicles with more towing capacity may have higher limits (e.g., on steering movement, or jerk) than vehicles with less towing capacity when there is heavy cargo, while vehicles with less towing capacity may have higher lateral limits when the cargo is light. The platform limit data 502 may be based on vehicle specification information, regulatory limits, weight distribution, or environment.

The proposer system 410 can process the road data 508, vehicle state data 505, and platform limit data 502 with a velocity profile generator 414 to generate a velocity profile 514. The velocity profile 514 can indicate a range of velocities performable by the autonomous vehicle based on the state of the autonomous vehicle and the acceleration limit. In some implementations, the velocity profile can include a range of velocities, a range of accelerations, or a range of jerks. The range of velocities may be descriptive of a minimum velocity and a maximum velocity for the autonomous vehicle based on the road data 508, vehicle state data 505, and platform limit data 502. The range of accelerations may be descriptive of a minimum acceleration and a maximum acceleration for the autonomous vehicle based on the road data 508, vehicle state data 505, and platform limit data 502. The range of jerks may be descriptive of a minimum jerk and a maximum jerk for the autonomous vehicle based on the road data 508, vehicle state data 505, and platform limit data 502.

The proposer system 410 can process the road data 508, vehicle state data 505, and platform limit data 502 with a lateral profile generator 412 to generate a lateral profile 516. The lateral profile 516 may indicate a range of lateral offsets from a path of the autonomous vehicle that are performable by the autonomous vehicle based on the state of the autonomous vehicle and the one or more steering limits. The lateral profile 516 can include a left offset, a right offset, or lateral rate of change range.

The proposer system 410 can constrain (or parameterize) the trajectory sampler 416 based on the ranges of the velocity profile 514 and the lateral profile 516. In particular, the trajectory sampler 416 can process the velocity profile 514, the lateral profile 516, and the road data 508 to generate (or sample) a plurality of initial candidate trajectories 418 within the ranges of the profiles. The initial candidate trajectories 418 include, for example, the first candidate trajectories generated by the autonomy system of the autonomous vehicle within a given cycle (e.g., motion planning cycle) or single end-to-end processing instance of the autonomy system. The velocity profile 514 and the lateral profile 516 can condition the trajectory sampler 416 to avoid generating (or sampling) candidate trajectories that would not be feasible for the autonomous vehicle. For example, a candidate trajectory that cannot be dynamically executed by the autonomous vehicle within its physical mechanical constraints (and operating requirements), is not considered feasible.

The ranker system 420 can perform a plurality of cost evaluations on the plurality of initial candidate trajectories 418. The ranker system 420 can generate cost data for each respective initial candidate trajectory of the plurality of initial candidate trajectories 418 based on the plurality of cost evaluations 422.

The cost data can be descriptive of resources that would be utilized for a candidate motion path associated with the respective initial candidate trajectory or may be descriptive of potential interactions with the environment for the respective initial candidate trajectory. The trajectory arbiter of the ranker system 420 may determine the selected trajectory based on the cost data associated with the plurality of initial candidate trajectories 418. The selected trajectory can be the candidate trajectory with a lowest cost.

Alternatively or additionally, a ranker model 424 of the ranker system 420 may rank the plurality of initial candidate trajectories 418 according to one or more costs associated with the respective candidate trajectory. In some implementations, the ranker model 424 may include one or more machine-learned models trained on human driving data. The human driving data can be descriptive of driving actions performed by humans in given driving instances. The one or more machined-learned models may be trained to determine a cost corresponding to a difference between a respective trajectory and a human driver's strategy in the same driving scenario. In some implementations, the ranker model 424 may consider the forecasted goal(s) or forecasted interaction(s) predicted for the actors within the environment when ranking the candidate trajectories.

The ranker model 424 may be leveraged to perform a trajectory selection 426. For example, the ranker model 424 may identify a selected trajectory based on the contextual data and one or more cost functions. The cost functions, for example, can include static cost functions that encode one or more desired driving behaviors such as, for example, avoiding lane boundaries, remaining near the center of a lane, avoiding acceleration or jerk, avoiding steering jerk, etc. In addition, or alternatively, the cost functions can include dynamic cost functions that can evaluate dynamic constraints. The dynamic cost functions, for example, can evaluate the forecasted goal(s), the forecasted interaction(s), or the continuous trajectories predicted for the actors within the environment.

The trajectory selection 426 can select a particular trajectory strategy for implementation by the autonomous platform. To do so, the ranker system 420 can reject one or more candidate trajectories that result in interference with other actors/objects, violate lane boundaries, etc. The trajectory selection 426 can select the selected trajectory from the non-rejected trajectories that optimizes (e.g., minimizes) the aggregate cost as evaluated by the static or dynamic cost functions. In some implementations, the ranker system 420 can select the selected strategy based on the forecasted goal(s) for the actors within the environment.

In some implementations, the one or more cost functions may include one or more decision conditioned cost functions to determine one or more decision condition cost values. For example, a different cost determination may be performed if the autonomous vehicle merges behind another vehicle than if the autonomous vehicle remains in the current lane. The ranker system 420 can leverage the one or more decision conditioned cost functions to evaluate a plurality of different costs of performing the particular decision, which can include hard braking, heavy acceleration, side-to-side movement, proximity to a shoulder, proximity to a barrier, a distance to goal change, or other potential costs stemming from the autonomous vehicle performing that decision. The one or more decision condition cost values can include an aggregated total or may include a plurality of values associated with a plurality of different cost metrics associated with changes caused by actions performed by the autonomous vehicle.

Additionally or alternatively, the ranker system 420 can utilize one or more decision independent cost functions to determine one or more decision independent cost values. The ranker system 420 can leverage the one or more decision independent cost functions 414 to evaluate a plurality of different costs that are independent of the decision selected. The one or more decision independent cost functions can evaluate cost associated with other actors in the environment (e.g., other vehicles, pedestrians, or animals), the static objects in the environment, the weather, or other factors that would affect the cost of traversing the environment regardless of the decision performed. The one or more decision independent cost values can include an aggregated total or may include a plurality of values associated with a plurality of different cost metrics associated with travel cost constants.

Moreover, the ranker system 420 can determine costs associated with low-cost coasting or potential high-cost interactions (e.g., braking by both the autonomous vehicle and another vehicle). Low-cost coasting can include driving instances in which energy consumption is reduced due to momentum being maintained with minimal to no braking or obstructive movement.

In some implementations, the ranker system 420 can perform the cost determinations based on one or more burden/control cost functions. For example, the strategic cost block can leverage the one or more burden/control cost functions to determine a burden cost for an acceleration or resource utilization cost of performing one or more control actions (e.g., turning or braking). This may include, for example, the cost of a burden to other actors-what it would take for other actors to respond (e.g., to a lane change maneuver). The system may aggregate the one or more decision condition cost values, the one or more decision independent cost values, and one or more other cost values to generate cost data that may then be utilized to perform trajectory selection 426. Trajectory selection 426 can include selecting a candidate trajectory from the plurality of initial candidate trajectories 418 based on the decision independent cost functions, the decision conditioned cost functions, the strategic cost data, or other cost mapping.

After trajectory selection 426, the parameter-based sampling system 400 can transmit the selected trajectory to a control system of the autonomous vehicle to cause the autonomous vehicle to execute a motion path based on the selected trajectory.

In some implementations, the velocity profile 514 or the lateral profile 516 may be generated or utilized to perform other tasks within a motion planning system. For example, the velocity profile 514 or the lateral profile 516 may be utilized for proposer system 410 testing, initial candidate trajectory validation, motion planning system auditing, or other tasks.

FIG. 5 is a block diagram of an example data flow pipeline 500 for trajectory generation based on determined profiles, according to some implementations of the present disclosure.

The data flow pipeline 500 can include obtaining a plurality of input data that the system 400 can process to generate a plurality of profiles that can guide the candidate trajectory sampling 518. For example, the data flow pipeline 500 can obtain platform limit data 502, initial state data 504, final state data 506, and road data 508. As described herein, the platform limit data 502 can be descriptive of one or more platform limits associated with an autonomous vehicle. The one or more platform limits may include a jerk limit or an acceleration limit. The initial state data 504 and the final state data 506 can be part of vehicle state data 505. The initial state data 504 can be descriptive of an initial location, initial velocity, or an initial acceleration for the autonomous vehicle. The final state data 506 can be descriptive of a desired final location, a desired final velocity, or a desired final acceleration during a time horizon. A time horizon can include a particular span of time in which a predicted trajectory is to forecast. The time horizon may span from a current time instance in time (and/or time at the end of a previous time horizon associated with a previous prediction) to an end time associated with an ending of a trajectory performed by a vehicle if a generated trajectory is performed. The road data 508 can be descriptive of road geometry (e.g., road curvature or road gradient), road conditions, road speed limits, or other road data.

The data flow pipeline 500 can process the platform limit data 502 and the vehicle state data 505 to determine an acceleration range 510 that is compatible with the one or more platform limits. The determination can be performed based on determining a jerk range from the jerk limit. The jerk range can be leveraged to determine the acceleration range 510. In some implementations, the data flow pipeline 500 may include determining the acceleration range 510 based in part on the road data 508. For example, the data flow pipeline 500 may adjust the acceleration range 510 based on a road geometry including the road gradient, road curves, and other relevant road features.

The system 500 can process the platform limit data 502, the vehicle state data 505, and the acceleration range 510 to determine a velocity range 512 that is compatible with the one or more platform limits. The determination can be performed based on determining an acceleration range 510 from the jerk range. The acceleration range 510 can be leveraged to determine the velocity range 512. In some implementations, the data flow pipeline 500 may include determining the velocity range 512 based in part on the road data 508. For example, the data flow pipeline 500 may adjust the velocity range 512 based on the road geometry including the road gradient, road curves, and other relevant road features.

The data flow pipeline 500 can generate a velocity profile 514 based on the velocity range 512, the acceleration range 510, or the jerk range. The velocity range 512, the acceleration range 510, or the jerk range can be leveraged as parameters for sampling or generating trajectories.

In particular, the velocity profile 514 can be descriptive of a range of velocities. This can include the bounds on a minimum and maximum velocity attainable at a given target time given the current autonomous vehicle state and the dynamics limits. Moreover, the velocity profile 514 may include a distance range, a velocity range 512, an acceleration range 510, or a jerk range.

The target speed at target time profile can be a quartic polynomial.

$$\begin{matrix}s ( t ) = B {t}^{4} + C {t}^{3} + D {t}^{2} + E t + F \\ v ( t ) = 4 B {t}^{3} + 3 C {t}^{2} + 2 D t + E \\ a ( t ) = 12 B {t}^{2} + 6 C t + 2 D \\ j ( t ) = 24 B t + 6 C\end{matrix}$$

The coefficients can be solved for by specifying the initial state [s₀, v₀, a₀] and the final state [v_{f}, a_{f}]. s_{f} (the final location) may be a free variable.

Given the autonomous vehicle initial state [s₀, v₀, a₀] and the time horizon t_{f}, the motion planning system may compute the max/min final velocity v(t_{f}) such that a(t_{f})=0. The jerk and acceleration limits constraints can be satisfied by the speed profile.

The coefficients D, E, F can be determined or obtained from the initial state. In some implementations, the system 400 may consider the jerk constraint for the first time step t=0

$${j}_{min} < 6 C < {j}_{max}$$

The system 400 may be coasting at the end of horizon, which can be represented as:

$$\begin{matrix}a ( {t}_{f} ) = 0 \\ 12 B {t}_{f}^{2} + 6 C {t}_{f} + 2 D = 0 \\ B = - ( 6 C {t}_{f} + {a}_{0} ) / 12 {t}_{f}^{2}\end{matrix}$$

In some implementations, the system 400 may consider the jerk constraints for the final time step:

$${j}_{min} < 24 B {t}_{f} + 6 C < {j}_{max}$$

The system 400 may substitute the value of B in terms of C from the above equation and simplifying as:

$$- {j}_{max} - 2 {a}_{0} / {t}_{f} < 6 C < - {j}_{min} - 2 {a}_{0} / {t}_{f}$$

The system 400 may get the time tₘ at which a (t) attains max/min value:

$$24 B t + 6 C = 0$$

$${t}_{m} = - C / 4 B$$

The max value of acceleration at that timestamp can be:

$$a ( {t}_{m} ) = 12 B {t}_{m}^{2} + 6 C {t}_{m} + {a}_{0}$$

The system may substitute the value of B in the above equation and simplifying as:

$$a ( {t}_{m} ) = ( \frac{3 {t}_{f}}{2} ) ( \frac{{C}^{2}}{C + {a}_{0} / 6 {t}_{f}} ) + {a}_{0} .$$

The motion planning system can ensure the above max value is less than equal to the max acceleration limit afforded to the planner. The max speed bound may be determined as shown below:

$$( \frac{3 {t}_{f}}{2} ) ( \frac{{C}^{2}}{C + {a}_{0} / 6 {t}_{f}} ) + {a}_{0} \leq {a}_{max}$$

$$( \frac{{C}^{2}}{C + {k}_{1}} ) \leq {K}_{2}$$

### Where,

K₁=a_{0/6}t_{f} and K₂=(2/3t_{f})(aₘₐₓ−a₀).

If C+K₁>0, then B<0 as

$$B = - ( 6 C {t}_{f} + {a}_{0} ) / 12 {t}_{f}^{2}$$

$$B = - ( C + {a}_{0} / 6 {t}_{f} ) / 2 {t}_{f}$$

$$B = - ( C + {K}_{1} ) / 2 {t}_{f}$$

Then, the acceleration curve may be concave in nature, which is what is utilized for the max speed determination. Based on the determination, the system 400 may not consider the solution corresponding to C+K₁<0.

Solving the above inequality, the system 400 may consider the case where, C+K₁>0, allowing for:

$${C}^{2} - {K}_{2} C - {K}_{1} {K}_{2} < 0$$

Two solutions of the quadratic can be as follows:

$${C}_{1} , {C}_{2} = 0.5 ( {K}_{2} \pm √ {K}_{2}^{2} + 4 {K}_{1} {K}_{2} )$$

The solutions can be real numbers, represented as, for example:

$${K}_{2}^{2} + 4 {K}_{1} {K}_{2} = ( 4 / 9 {t}_{f} ) ( {a}_{max} - {a}_{0} ) {a}_{max} > 0$$

Then, the inequality may be shown as:

$$( C - {C}_{1} ) ( C - {C}_{2} ) < 0$$

$${C}_{1} < C < {C}_{2}$$

The system 400 can determine the feasible interval for C by solving for the intersections of the following:

$${C}_{1} < C < {C}_{2} and C + {K}_{1} > 0$$

$${j}_{min} < 6 C < {j}_{max}$$

$$- {j}_{max} - 2 {a}_{0} / {t}_{f} < 6 C < - {j}_{min} - 2 {a}_{0} / {t}_{f}$$

If −K₁>C₂, then there may not be a feasible value of C that respects the acceleration limits. In that case, the system 400 may use the value corresponding to max jerk from the other two constraints. From the max value of C, the system can determine the value of B to enforce a(t_{f})=0. The determination can provide the system 400 with the coefficients for the quartic speed profile. The system 400 may determine the max speed at the time horizon v(t_{f}):

$$v ( {t}_{f} ) = 4 {Bt}_{f}^{3} + 3 {Ct}_{f}^{2} + 2 {Dt}_{f} + E$$

$$B = - ( 6 C {t}_{f} + {a}_{0} ) / 12 {t}_{f}^{2}$$

$$2 D = {a}_{0}$$

$$E = {v}_{0} .$$

The system 400 may be configured to set up similar inequality for minimum acceleration:

$${a}_{min} = ( \frac{3 {t}_{f}}{2} ) ( \frac{{C}^{2}}{C + {a}_{0} / 6 {t}_{f}} ) + {a}_{0}$$

$${K}_{3} \leq ( \frac{{C}^{2}}{C + {k}_{1}} )$$

### Where,

K₁=a_{0/6}t_{f} and K₃=(2/3t_{f})(aₘᵢₙ−a₀)

The system may consider the case where C+K₁<0, so that B>0 and the acceleration profile is convex, which is what may be requested for determining the min achievable speed. The inequality can then be:

$${C}^{2} - {K}_{3} C - {K}_{1} {K}_{3} < 0$$

Two solutions of the quadratic can be as follows:

$${C}_{3} , {C}_{4} = 0.5 ( {K}_{3} \pm √ {K}_{3}^{2} + 4 {K}_{1} {K}_{3} )$$

The solutions can be real numbers, shown as, for example:

$${K}_{3}^{2} + 4 {K}_{1} {K}_{3} = ( \frac{4}{9 {t}_{f}} ) ( {a}_{min} - {a}_{0} ) {a}_{min} > 0$$

provided aₘᵢₙ<0
   Then, the inequality can be:

$$( C - {C}_{3} ) ( C - {C}_{4} ) < 0$$

$${C}_{3} < C < {C}_{4}$$

The system 400 can get the feasible interval for C by solving for the intersections of the following:

$${C}_{3} < C < {C}_{4} and C + {K}_{1} < 0$$

$${j}_{min} < 6 C < {j}_{max}$$

$$- {j}_{max} - 2 {a}_{0} / {t}_{f} < 6 C < - {j}_{min} - 2 {a}_{0} / {t}_{f}$$

If −K₁<C₃, then there may be no feasible value of C that respects the acceleration limits. In that case, the system 400 can use the value corresponding to min jerk from the other two constraints. From the min value of C, the system may determine the value of B. The determination can provide the coefficients for the quartic speed profile. Then, the system 400 can determine the min speed at the time horizon v(t_{f}):

$$v ( {t}_{f} ) = 4 {Bt}_{f}^{3} + 3 {Ct}_{f}^{2} + 2 {Dt}_{f} + E$$

$$B = - ( 6 C {t}_{f} + {a}_{0} ) / 12 {t}_{f}^{2}$$

$$2 D = {a}_{0}$$

$$E = {v}_{0} .$$

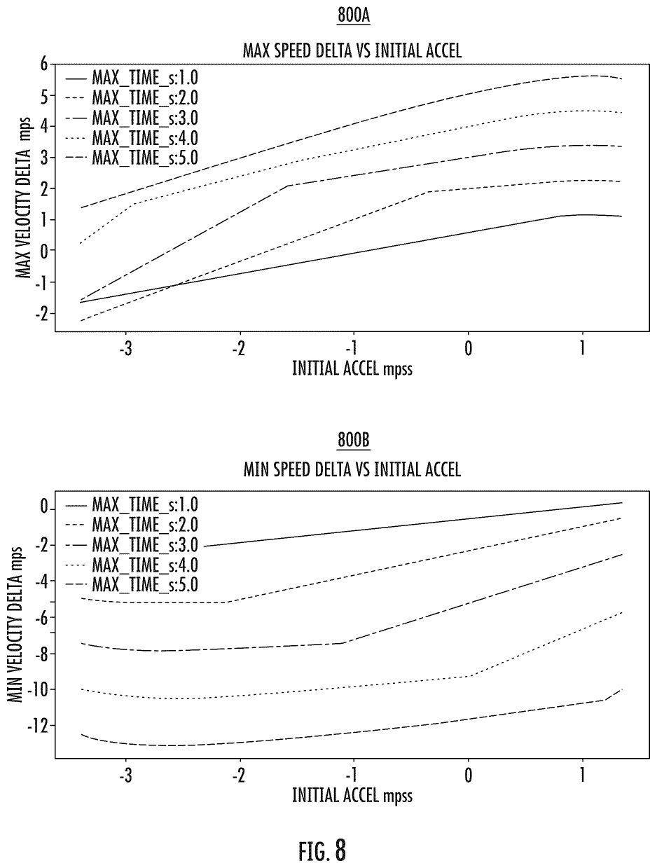

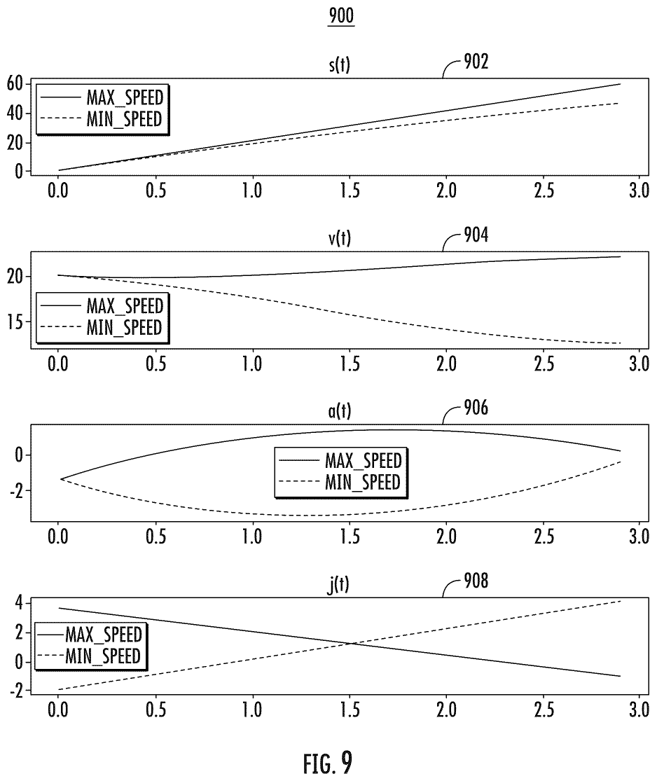

Example plots depicting example velocity profiles 514 are discussed below with relation to FIGS. 8-9.

Additionally or alternatively, the data flow pipeline 500 can process the platform limit data 502 or the road data 508 to generate a lateral profile 516. The lateral profile 516 can be descriptive of a range of lateral offsets (e.g., a right offset and a left offset) or steering rate of change ranges that are compatible with the platform limits. In some implementations, the data flow pipeline 500 may include generating the lateral profile 516 based in part on the road data 508. For example, the data flow pipeline 500 may adjust the range of lateral offsets steering rate of change ranges based on the road geometry including the road gradient, road curves, and other relevant road features.

Generating the lateral profile 516 may include determining the minimum and maximum lateral offsets achievable at a target longitudinal distance, given the current autonomous vehicle state and the dynamics limits. The lateral offsets can be or be based on a road wheel angle range descriptive of a minimum road wheel angle and a maximum road wheel angle. The road wheel angle may be measured from true vertical and may be associated with the wheel turn of the steering wheel. Additionally or alternatively, the lateral profile 516 can include or be based on a road wheel angle rate of change range. For example, the road wheel angle rate of change range can be descriptive of a minimum road wheel angle rate of change and a maximum road wheel angle rate of change.

The minimum and maximum road wheel angle rate and road wheel angle values may be a function of autonomous vehicle speed. The road wheel angle rate and road wheel angle limits can give bounds on the spatial curvature and spatial curvature rate that the spatial path is to adhere to for dynamic feasibility. The bounds can be used to derive the max-min values for initial lateral jerk in the Frenet space.

The system 400 may limit the Frenet lateral jerk d″ at the first point on the lateral profile 516:

$$\frac{{K}_{5} ( Δ {θ}_{min}^{′′} + {K}_{3} ) - {K}_{4}}{{α}_{0}} < {d}_{0}^{′′′} < \frac{{K}_{5} ( Δ {θ}_{max}^{′′} + {K}_{3} ) - {K}_{4}}{{α}_{0}}$$

The above limits may be for initial lateral jerk and may, for example, only be a function of autonomous vehicle initial state, the curvature properties of a basis path and the woad wheel angle rate limits. As further described herein a basis path can include a set of anchors for anchoring a given trajectory for a given route. The basis path may trace a centerline of a lane. The basis path may be selected based on initial scene information from a context cache, such as actor data (e.g., actor state data) and ego vehicle state data. Initial candidate trajectories 418 may be parameterized in terms of a basis path and lateral offsets from that basis path over time. The bounds on Frenet acceleration at the first point on the lateral profile 516 can be determined as follows:

$$\frac{{k}_{5} {Δθ}_{0}^{min′} + {k}_{6}}{{α}_{0}} < {d}_{0}^{″} < \frac{{k}_{5} {Δθ}_{0}^{max′} + {k}_{6}}{{α}_{0}}$$

The bounds may, for example, only be valid for the initial point of the lateral profile 516. The max and min value of lateral jerk, acceleration may change with the current Frenet state, curvature properties of the basis path and may not be constant throughout the lateral profile 516. However, the above values may be used as heuristic estimates.

The lateral profile 516 as a function of longitudinal distance s can be defined by a quintic polynomial:

$$d ( s ) = A {s}^{5} + B {s}^{4} + C {s}^{3} + D {s}^{2} + E s + F$$

$$d ’ ( s ) = 5 A {s}^{4} + 4 B {s}^{3} + 3 C {s}^{2} + 2 D s + E$$

$$d ” ( s ) = 20 A {s}^{3} + 12 B {s}^{2} + 6 C s + 2 D$$

$$d ’ ’ ’ ( s ) = 60 A {s}^{2} + 24 B s + 6 C$$

Fitting the above quintic can rely on specifying the full initial and the final Frenet state.

The coefficients D, E, F can be obtained from the autonomous vehicle's initial Frenet state [d₀, d′₀, d₀″], that represents the autonomous vehicle initial lateral offset, lateral velocity, and lateral acceleration.

From the bounds on initial lateral jerk established in the section above, the system 400 can have:

$${j}_{min} < 6 C < {J}_{max}$$

From, the boundary conditions, the system 400 may solve for the coefficient C in terms of initial and final Frenet state:

$$C = \frac{1}{2} ( {d}_{f}^{″} - 3 {d}_{0}^{″} ) x + 10 ( {d}_{f} - {d}_{0} ) {x}^{3} - ( 4 {d}_{f}^{′} - 6 {d}_{0}^{′} ) {x}^{2}$$

where, x=1/s_{f} and s_{f} is the final or the target longitudinal distance for the lateral profile 516.

The system 400 may determine or define a constant as:

$$K = \frac{1}{2} ( {d}_{f}^{″} - 3 {d}_{0}^{″} ) x - ( 4 {d}_{f}^{′} - 6 {d}_{0}^{′} ) {x}^{2}$$

The system may set d_{f}″=0 and d_{f}′=0 so that the spatial path is aligned with the basis path, wicket stream at the end of the profile. Then, the system may determine the bounds on the final lateral offset as

$$\frac{{s}_{f}^{3}}{10} ( \frac{{j}_{min}}{6} - K ) + {d}_{0} < {d}_{f} < \frac{{s}_{f}^{3}}{10} ( \frac{{j}_{max}}{6} - K ) + {d}_{0}$$

For the quintic profile, enforcing the lateral acceleration constraints can be a bit cumbersome as the acceleration profile is a cubic polynomial. The range for max and min lateral offset can be determined based on the initial state data.

$$\frac{{s}_{f}^{3}}{10} ( \frac{{j}_{min}}{6} - K ) + {d}_{0} < {d}_{f} < \frac{{s}_{f}^{3}}{10} ( \frac{{j}_{max}}{6} - K ) + {d}_{0}$$

Constraining the final lateral offset parameter with the inequality above may guarantee that the road wheel angle rate, or the curvature rate may be within bounds for the first point on the trajectory. However, changes in autonomous vehicle speed and basis path curvature may not be factored into the above inequality. The lack of factoring may cause invalidities in the trajectory at later timestamps.

In order to address the invalidities, the system 400 may be configured to leverage a one dimensional search during sampling. For example, a vector of longitudinal offsets may be provided as an input parameter during sampler parameter generation. For a given longitudinal offset s_{f}, the final lateral offset d_{f} may be the only parameter to be decided in order to obtain a quintic lateral profile 516: d(s)=A s⁵+B s⁴+C s³+D s²+E s+F.

The parameter limiting may be performed for a fixed the initial condition [d₀, d′₀, d₀″], and the system 400 may request d_{f}″=0, d_{f}′=0, such that the spatial path is aligned with the basis path after attaining the lateral offset d_{f}

The above inequality can provide an initial min/max value for d_{f}, so that

$${d}_{f}^{max} = \frac{{s}_{f}^{3}}{10} ( \frac{{j}_{max}}{6} - K ) + {d}_{0} and {d}_{f}^{min} = \frac{{s}_{f}^{3}}{10} ( \frac{{j}_{min}}{6} - K ) + {d}_{0} .$$

The system 400 can then obtain the corresponding min/max offset lateral profile 516.

In order to check the validity of these min/max offset lateral profiles 516, the system 400 may obtain as input two additional sources of information: (1) the velocity profile 514 and (2) the basis path curvature profile. The velocity profile 514 can describe, for example, a speed profile, which may include a coasting speed profile, or −3.5 m/s\hat{ }2 braking profile, which gives maximum range of steering controls. This can help provide information about the road wheel angle rate/curvature rate limits at any point in the trajectory. The basis path curvature profile can be leveraged to determine the curvature rate at any trajectory point.

If provided a given speed profile, basis path, longitudinal offset s_{f}, the initial min/max value of d_{f} result in invalidity, the system can solve the following optimization problem:

$$min / max {d}_{f}$$

$$subject to : {d}_{f} ∈ [ {d}_{f}^{min} , {d}_{f}^{max} ]$$

$${k ’}_{min} ( s ) < k ’ ( s , {d}_{f} ) < {k ’}_{max} ( s ) ∀ s ∈ [ 0 , {s}_{f} ]$$

The above problem can perform a one dimensional search between the initial range d_{f}∈[d^{min}_{f}, d^{max}_{f}] to find a feasible final lateral offset that can satisfy the curvature rate constraints at any point. The system 400 can find the basis path point with the corresponding s where maximum violation among the constraints occurs and may conduct search only to satisfy inequality for that point.

The equation for curvature rate k′ (s, d_{f}) at any s given lateral profile 516 corresponding to d_{f} may be a nonlinear equation

$$( e . g . , {p}_{q} . twist = \frac{{cos}^{2} ( Δθ )}{{α}^{2}} ( {b}_{q} . twist + {Δθ}^{″} ) - cos ( Δθ ) \frac{αΔθ′sin ( Δθ ) + α′cos ( Δθ )}{{α}^{3}} ( {b}_{q} . curv + {Δθ}^{′} ) ) .$$

The inequality k′min(s)<k′ (s, d_{f})<k′ₘₐₓ(s) can be solved by performing standard line search, until the first feasible solution is obtained.

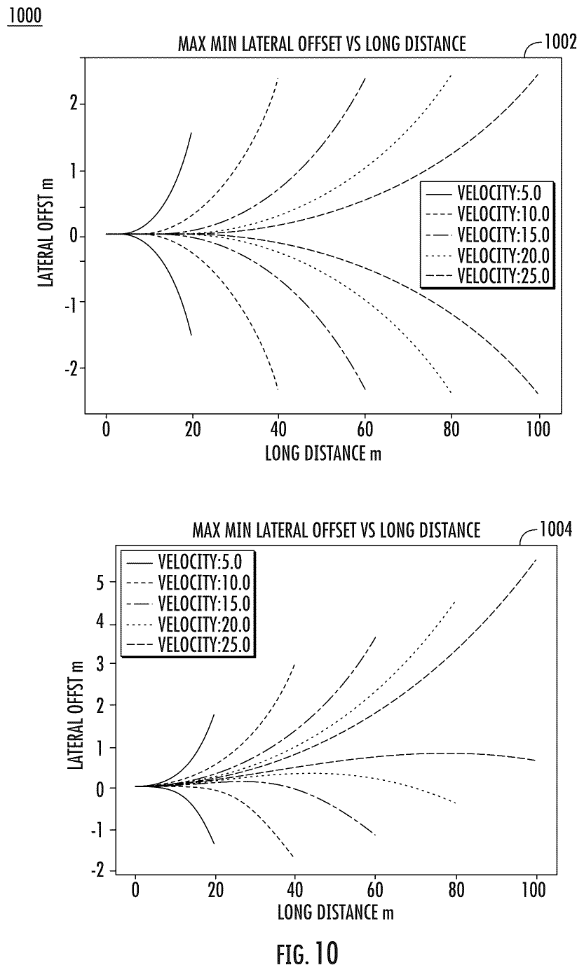

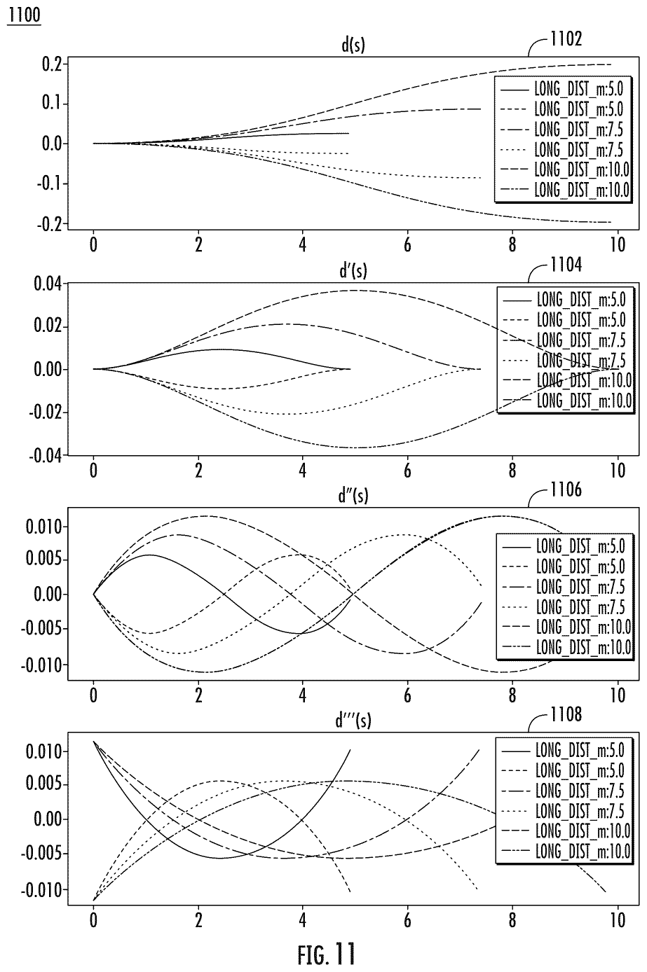

Example plots depicting example lateral profiles 516 are discussed below with relation to FIGS. 10-11.

The data flow pipeline 500 can process the velocity profile 514, the lateral profile 516, and the road data 508 to perform candidate trajectory sampling 518. In some implementations, the velocity range 512, the acceleration range 510, the jerk range, the lateral offset range, and the steering rate of change ranges can condition or guide the generation of a plurality of initial candidate trajectories.

The proposer system 410 (e.g., using the trajectory sampler model 416) can be responsible for generating a large number of dynamically feasible trajectories that the autonomous vehicle could use to navigate the environment. The trajectories can be sent to the ranker system 410 model to be costed and select a particular one to be executed, as described herein.

The trajectory sampler 416 can generate a variety of velocity profiles 514 and spatial paths. Each velocity profile 514 may be combined with each spatial path to produce a trajectory. Each trajectory can be checked for dynamic feasibility with respect to the vehicle model parameters and the velocity-dependent steering and acceleration limits. The invalid trajectories may be rejected and only the feasible “samples” are sent to the ranker. The trajectory sampling may be performed on the graphics processing unit of an autonomous vehicle.

The proposer system 410 may have a high recall rate and may produce at least one trajectory that closely mimics how an expert human driver might navigate in the environment. In some implementations, the proposer system 410 may generate a large number of other plausible and dynamically feasible trajectories, including evasive maneuvers (e.g., evasive braking, evasive steering). In some implementations, the proposer system 410 may leverage the output of an iterative linear quadratic regulator (iLQR) optimizer. The proposer system 410 may construct additional trajectories that are based on the iLQR trajectory by varying certain trajectory parameters.

The technical solutions disclosed herein can improve the functionality of the computing hardware of the vehicle, as well as the autonomous motion control of the vehicle, by utilizing intelligent heuristics for proposing the input parameters. The heuristics can be based on reachability analysis and may be conditioned on the autonomous vehicle initial state and dynamics limits to compute the range of feasible motion for the autonomous vehicle. This can improve the validity of the velocity and lateral profiles 516, 516 and finally the corresponding trajectories.

Furthermore, the motion planning system disclosed herein can increase the validity rate of the trajectories by intelligent sampling of the input parameters. The motion planning system can leverage a heuristic to sample target speeds based on the jerk and acceleration limits. The motion planning system can use this to increase the validity rate of the velocity profiles 514. In some implementations, the motion planning system can leverage a heuristic to sample lateral offsets based on road wheel angle rate (e.g., the steering angle rate) (or the corresponding lateral jerk) limits. The motion planning system can use this to increase the validity of lateral profiles 516 and the corresponding spatial paths. The generated profiles may be leveraged to improve the validity of trajectory samples.

Non-directed trajectory generation systems may lead to the generation of invalid trajectories. The trajectories may be invalid, for example, due to the road wheel angle rate being out of the appropriate bounds. The road wheel angle rate of the trajectory may be a function of the lateral profile/spatial path curvature and curvature rate, basis path curvature, and curvature rate. The road wheel angle rate limits (bounds) can be a function of current autonomous vehicle speed. Hence, the root cause of road wheel angle rate being out of bounds in a non-directed system may be multifaceted: the lateral profile 516 may be too aggressive, given the autonomous vehicle current speed (e.g., speed during lateral maneuver) and Frenet (e.g., (d, d′, d″), which corresponds to position or lateral offset, velocity, and acceleration in the Frenet space) initial state. This may result in a curvature/curvature rate spike in the basis path.

The technology disclosed herein implements a solution for the road wheel angle rate being out of bounds and caused invalid trajectory generation, by taking into consideration the autonomous vehicle initial speed, Frenet initial state, basis path information, or dynamics limits for lateral profile design.

Another reason for invalidity in non-directed trajectory generation systems may include the jerk being or acceleration being out of the appropriate bounds. These can point to limitations in the parameter proposals for the speed at target time velocity profiles 514. If given a very aggressive target speed and a short target time, either the jerk or acceleration may exceed the dynamics limits. The acceleration limits may be a function of autonomous vehicle current speed. The systems and methods disclosed herein may implement a solution for the above invalidity, which may consider the autonomous vehicle's initial longitudinal state and dynamics limits.

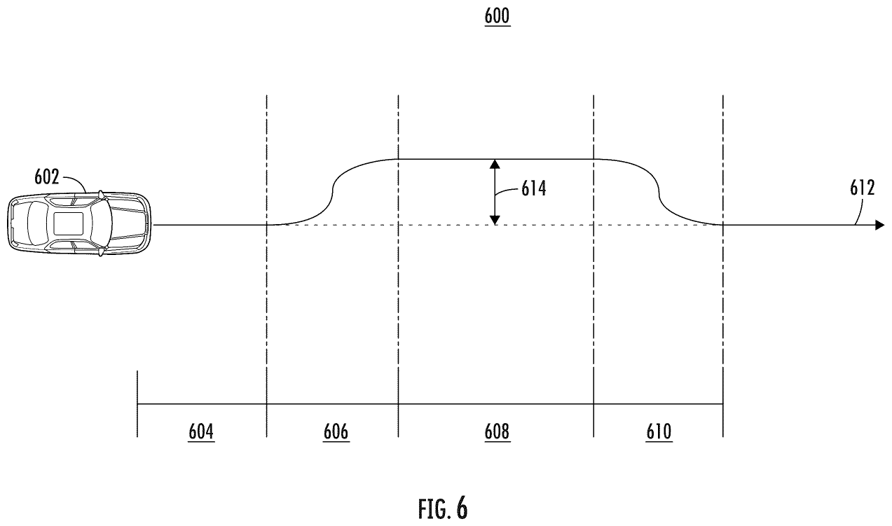

FIG. 6 is a representation of an example spatial path 600, according to some implementations of the present disclosure. The trajectory sampler 416 can construct a spatial path 600 by taking a 1D Frenet space profile and performing the Frenet to Cartesian transformation with respect to a given basis path 612. The Frenet space profile, encoded as a quintic polynomial, may give the lateral distance/offset (e.g., as shown by 614) with respect to the basis path 612 as a function of longitudinal distance (arc length).

The parameterization of the Frenet profiles can be shown in FIG. 6 and may be designed to define lateral shifts with respect to a basis path 612. The lateral shifts, or the Frenet lateral profile 516, may be a continuous sequence of quintic (degree 5) polynomial segments and may not be represented by sample points. The inputs for obtaining this quintic polynomial may be the initial and final Frenet states and the longitudinal distance to go from the initial to final state.

In an example, a spatial path 600 may have separate segments representative of the trajectory of the autonomous vehicle for a given time horizon. Each segment may include different velocities or lateral offsets, based on the velocity profile 514 and lateral profile 516 determined for the respective segment (e.g., generated for the respective time horizon, during the associated processing/planning cycle). The first segment 604 can include determining the autonomous vehicle stays at an initial lateral offset distance. The second segment 606 can include determining a distance to reach a target lateral offset. The third segment 608 can include determining a distance to stay at target lateral offset. The fourth segment 610 may include determining a distance to return to the basis path 612.

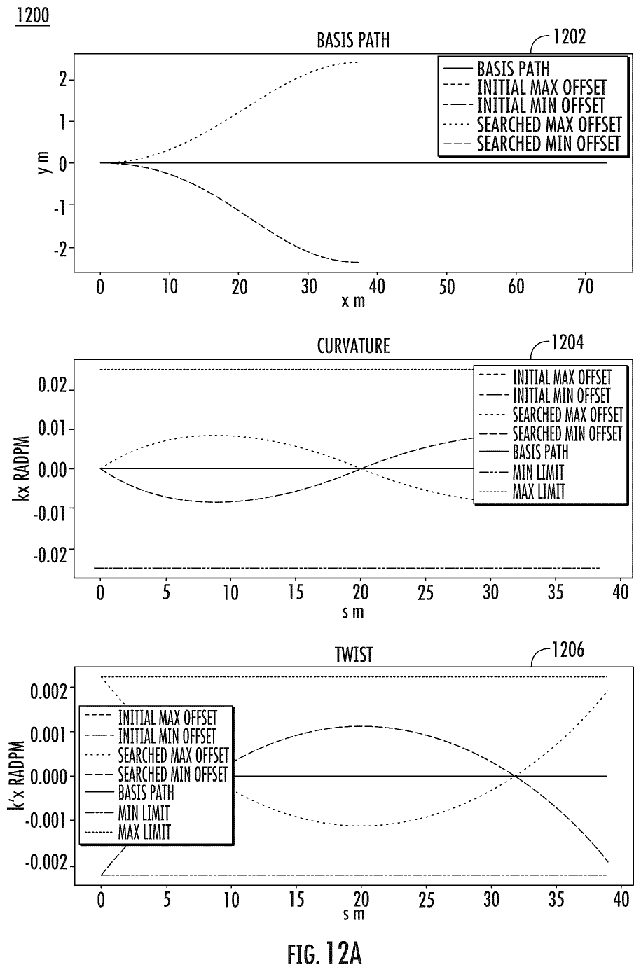

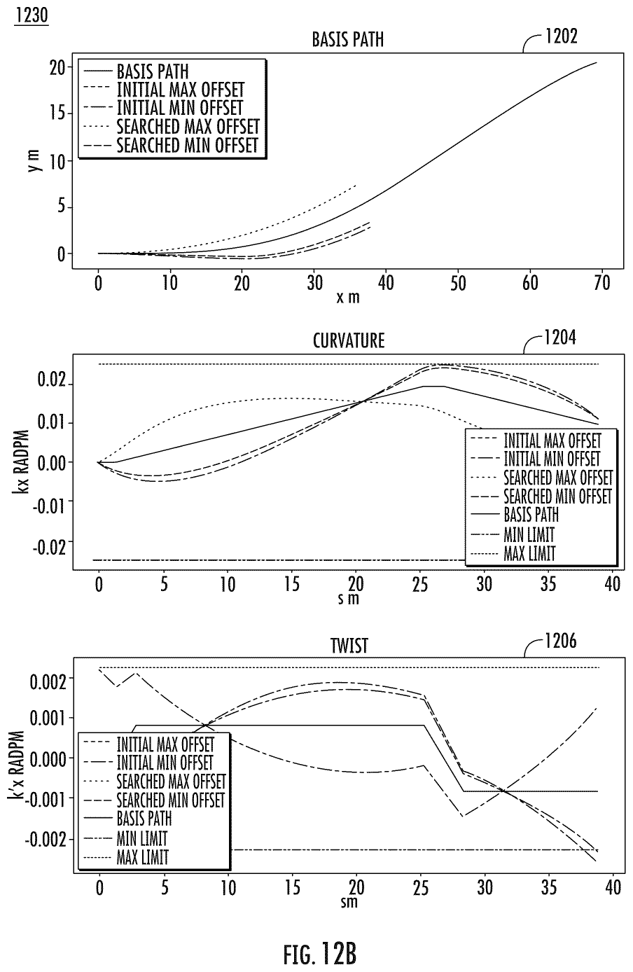

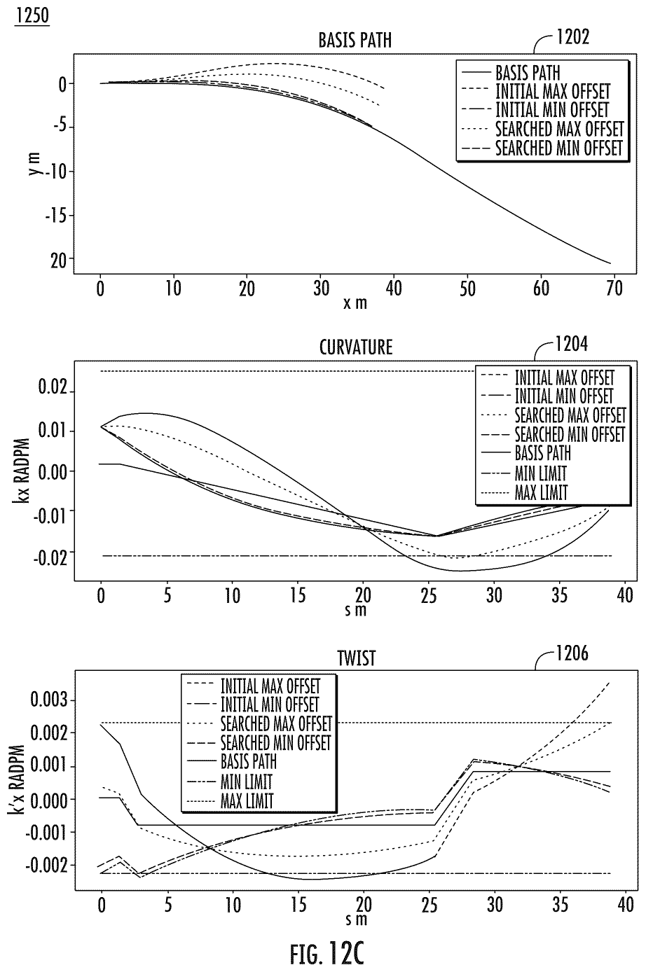

Example plots relating to example basis paths are discussed below with relation to FIGS. 12A-12C.

Again with reference to FIG. 5, in some implementations, the system 400 may leverage the target speed, target time type, and velocity profile 514 to parameterize trajectory generation. The “validity” of the input parameters may be ensured based on setting a target speed to achieve and setting a target time. The system 400 can compute the minimum target time required to achieve the target speed, based on the initial state data 504 (e.g., current acceleration, velocity) and the platform limit data 502 (e.g., describing dynamics limits/physical constraints based on current operating parameters). The system 400 can ensure that the target time is greater than or equal to this minimum target time. For example, the system 400 can compute the minimum and maximum target speed achievable at the target time given the current autonomous vehicle state and dynamics limits (e.g., The system can ensure that the target speed is between the minimum and maximum achievable speed.

In some implementations, the system 400 may determine the velocity profile 514 based at least in part on a quintic polynomial in time. Solving for the minimum time may amount to a non-linear constrained optimization problem. The system 400 may solve a set of inequalities to get the appropriate range of values for the coefficients for the polynomial.

In some implementations, the system 400 may generate the lateral profile 516 in parallel to the generation of the velocity profile 514. The lateral profile 516 determination may include obtaining a longitudinal distance. The system 400 can compute the maximum and minimum lateral offsets achievable, given the current autonomous vehicle state, dynamics limits, and the spatial limits afforded by the longitudinal distance. The system 400 can sample the longitudinal and lateral offset combination in an informed manner using these bounds to increase the validity rate. The system 400 can perform the sampling in an informed manner by confining the generation (or sampling) to ranges from the velocity profile 514 and the lateral profile 516. For example, the system 400 can avoid sampling trajectories that would have lateral offsets that are outside the lateral offset range of the lateral profile 516 or can avoid sampling trajectories that would have velocities that are outside of the velocity range 512 of the velocity profile 514.

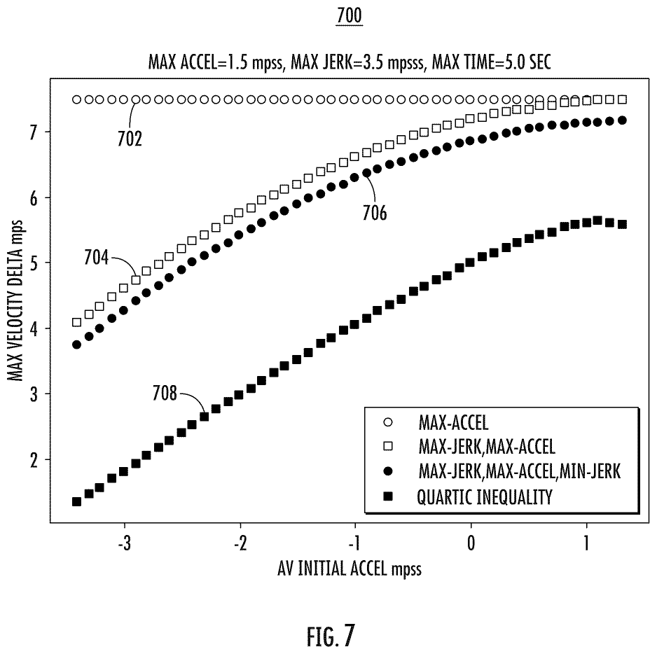

FIG. 7 is a representation of an example plot 700 of maximum velocity change, according to some implementations of the present disclosure. In particular, FIG. 7 can depict a plot 700 of max change in the speed possible at target time of 5 sec as a function of autonomous vehicle initial acceleration. The plot 700 can provide the values obtained by different heuristic methods including the quartic inequality described above. The quartic inequality method can provide an effective (min) heuristic value for max speed. The max acceleration line 702 as plotted can be linear, while the max-jerk, max-accel line 704, the max-jerk, max-accel, min-jerk line 704, and the quartic inequality line may be curved with a limit. As depicted, the quartic inequality 708 may have the lowest max velocity delta mps.

FIG. 8 includes example plots 800A-B of maximum and minimum values of attainable speed deltas, according to some implementations of the present disclosure. For example, plot 800A conveys the maximum values and plot 800B conveys the minimum values 804 of attainable speed deltas as a function of initial acceleration for different target times. The minimum acceleration limit can be −3.5 mpss, which can be higher than the max acceleration limit of 1.5 mpss.

The plots 800A-B for max and min speed delta may be asymmetric. For example, the minimum speed delta for a target time (e.g., of 4, 5 seconds) can provide pretty low values (e.g., less than −10.0 mps). The plots 800A-B may not respect the constraint that the velocity relies on to be greater than or equal to zero. The heuristic values can be clamped to be within the required bounds. For example, the plot 800A of max speed delta with initial acceleration near-3.5 mpss can provide a higher value for 1 second target time than 2 sec. The change in speed may have a more negative value at 2 seconds than 1 second as the acceleration is negative, even if max positive jerk is applied for the entire duration.

FIG. 9 is a representation of an example plots 900 of velocity profiles 514 based on minimum and maximum parameters, according to some implementations of the present disclosure. For example, the plots 900 can depict the velocity profiles 514 achieving the max and min speeds possible for an initial velocity and acceleration of 20.0 mps and −1.4 mpss with target time of 3 sec. FIG. 9 depicts a distance plot 902, a velocity plot 904, an acceleration plot 906, and a jerk plot 908. In an example, the distance divergence can be relatively mild, while the velocity divergence may be more noticeable. The acceleration plot 906 can reach the max limit value for the max speed profile before going to zero at the end of profile time. Moreover, the acceleration plot 906 can depict a divergence followed by sinusoidal convergence. In an example, the jerk plot 908 can depict a single intersection. The plots 800 and 900 of FIGS. 8-9 along with the plots that follow represent the described scenarios for example purposes only and are not intended to be limiting.

FIG. 10 is a representation of an example plots 1000 of lateral profiles 516, according to some implementations of the present disclosure. For lower velocities, the system 400 can have higher Frenet jerk margins, such that the system 400 can gain a larger spread of lateral offsets (e.g., as reflected in velocity 5.0 plot line). At higher speeds, the system 400 can have more stringent margins on Frenet jerk. The Frenet jerk may take higher longitudinal distances to get the same lateral offset (e.g., as reflect in velocity 25.0 plot line).

The plot 1002 is an example for the Frenet initial state of [0.0,0.0,0.0], e.g., the initial lateral acceleration and velocity is zero. The basis path curvature and twist can be zero as well. The plot for max and min lateral offset can be symmetric. The values may vary with the initial state and basis path curvature. The plot 1004 is an example that depicts offsets with Frenet initial state of [0.0, 0.01, 0.005].

FIG. 11 is a representation of an example plots 1100 of maximum and minimum offsets for a lateral profile 516, according to some implementations of the present disclosure. In particular, FIG. 11 depicts a plot of a max and min offset lateral profile and their derivatives at 5 mps for different longitudinal distances. The first graph 1102 depicts a lateral offset range plot. The second graph 1104 depicts a lateral offset rate of change range plot. The third graph 1106 depicts a lateral offset acceleration range plot. The fourth graph 1108 depicts a lateral offset jerk range plot. For all the profiles, the Frenet final acceleration and velocity may be zero. The initial Frenet jerk may be within the bounds.

FIG. 12A is a representation of a first example basis path plot 1200, according to some implementations of the present disclosure. In particular, FIG. 12A can depict an example straight basis path with initial condition [d₀, d′₀, d₀″]=[0,0,0]. In the depicted graphs, the lateral profiles 516 corresponding to [d^{min}_{f}, d^{max}_{f}] may be valid and may not rely on further optimization. The first graph 1202 depicts the basis path offset range. The second graph 1204 depicts the curvature offset ranges. The third graph 1206 depicts the twist offset ranges. The twist offset ranges can be associated with a steering wheel angle acceleration range 510 that is dynamically feasible for the autonomous vehicle.

FIG. 12B is a representation of a second example basis path plot 1230, according to some implementations of the present disclosure. In particular, FIG. 12B can depict an example of initial condition [d₀, d′₀, d₀″]=[0,0,0], but curvature in the basis path causing the initial min lateral offset profile to have curvature rate violation. The curvature in the basis path can cause invalid generation in traditional systems; however, the motion planning system disclosed herein can be leveraged to mitigate or eliminate the invalid trajectory generation instances. The first graph 1202 depicts the basis path offset range for when a curvature in the basis path traditionally causes the initial min lateral offset profile to have curvature rate violation. The second graph 1204 depicts the curvature offset ranges for when a curvature in the basis path traditionally causes the initial min lateral offset profile to have curvature rate violation. The third graph 1206 depicts the twist offset ranges for when a curvature in the basis path traditionally causes the initial min lateral offset profile to have curvature rate violation.

FIG. 12C is a representation of a third example basis path plot 1250, according to some implementations of the present disclosure. In particular, FIG. 12C can depict an example with initial condition [d₀, d′₀, d₀″]=[0,0,0.1] and curved basis path in the direction opposite to Frenet lateral acceleration. Initial min/max lateral offset profiles may be both invalid with respect to curvature rate limits and may be corrected by the approach described herein. The approach can leverage full basis path and a set velocity profile information to find lateral profile parameters s_f and d_f that have higher probability of being valid given the constraints. The approach can handle violations at any time throughout the planning horizon and can be extended to include the lateral acceleration (curvature) violation constraints. This can boost the validity of the proposer and prevent invalid trajectory design. The first graph 1202 depicts the basis path offset range for when the initial condition is [d₀, d′₀, d₀″]=[0,0,0.1] and curved basis path in the direction opposite to Frenet lateral acceleration. The second graph 1204 depicts the curvature offset ranges for when the initial condition is [d₀, d′₀, d₀″]=[0,0,0.1] and curved basis path in the direction opposite to Frenet lateral acceleration. The third graph 1206 depicts the twist offset ranges for when the initial condition is [d₀, d′₀, d₀″]=[0,0,0.1] and curved basis path in the direction opposite to Frenet lateral acceleration.

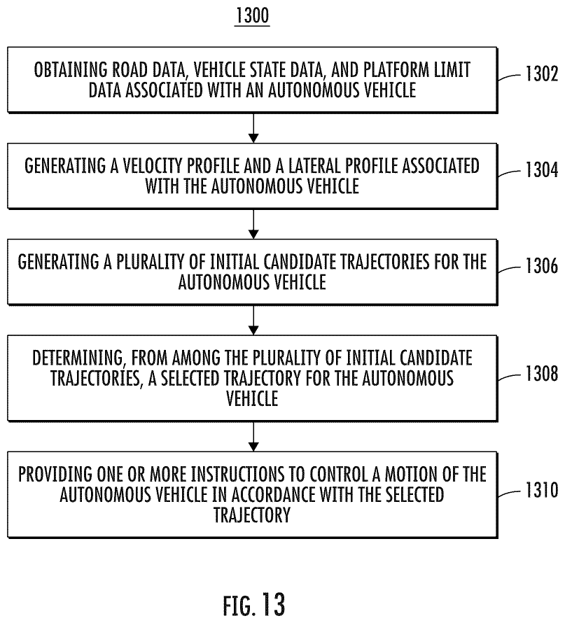

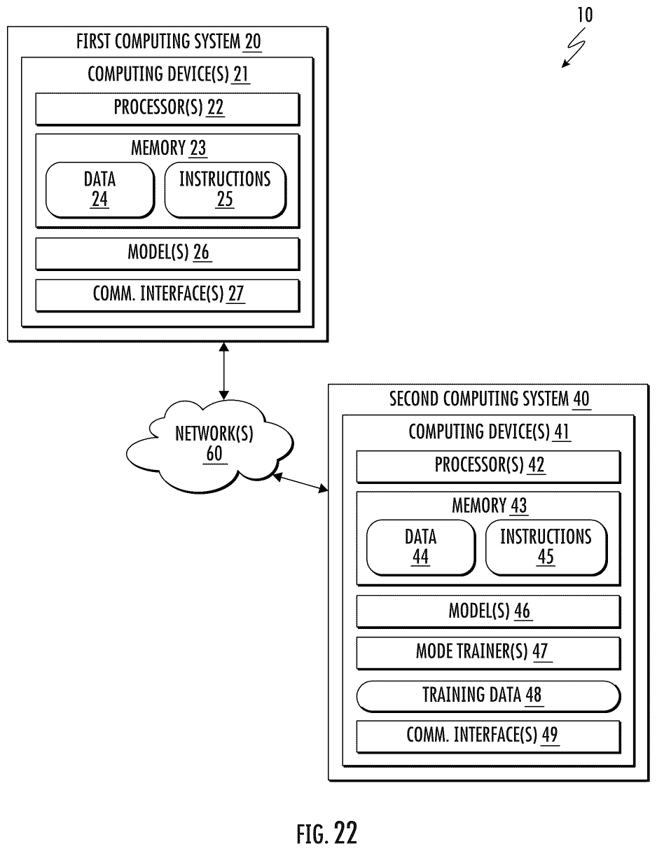

FIGS. 13-19 depicts flowcharts of example methods according to aspects of the present disclosure. One or more portion(s) of the methods described in FIGS. 13-19 can be implemented by a computing system that includes one or more computing devices such as, for example, the computing systems described with reference to the other figures (e.g., autonomous platform 110, vehicle computing system 180, remote system(s) 160, a system of FIG. 22, etc.). Each respective portion of the methods can be performed by any (or any combination) of one or more computing devices. Moreover, one or more portion(s) of the methods can be implemented on the hardware components of the device(s) described herein (e.g., as in FIGS. 1, 2, 22, etc.). FIGS. 13-19 depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIGS. 13-19 are described with reference to elements/terms described with respect to other systems and figures for exemplary illustrated purposes and is not meant to be limiting. One or more portions of the methods can be performed additionally, or alternatively, by other systems.

FIG. 13 depicts a flowchart of a method 1300 for controlling an autonomous vehicle according to aspects of the present disclosure. The method 1300 may be performed by a computing system including, for example, a computing system of the autonomous vehicle.

At 1302, the method 1300 can include obtaining road data 508, vehicle state data 505, and platform limit data 502 associated with an autonomous vehicle. A computing system can obtain this data from its onboard memory resources or from one or more remote data sources. As described herein, the road data 508 can be indicative of one or more characteristics of one or more roads within an environment of the autonomous vehicle. In some implementations, the one or more characteristics can include the gradient of the road, the curves of the road, stop lights, stop signs, speed limits, historical traffic data, number of lanes, presences of a shoulder, the lines, or other characteristics. The one or more roads can include a road associated with the initial location of the autonomous vehicle during a time horizon of a trajectory prediction. For example, the autonomous vehicle may be planning a trajectory to perform when reaching a given point, and the one or more roads can include the road in which the autonomous vehicle will be on at the given point that is the starting point of the prediction time horizon.

Additionally or alternatively, the one or more roads can include one or more roads associated with a current road or the autonomous vehicle. This may include one or more roads on a navigation route.

The vehicle state data 505 can be indicative of a state of the autonomous vehicle. In some implementations, the vehicle state data 505 may be descriptive of an initial state of the autonomous vehicle during a trajectory prediction time horizon. The state of the autonomous vehicle can include an initial velocity and an initial acceleration of the autonomous vehicle. This can include a current velocity, steering angle, and acceleration of the vehicle during a current time horizon.

The platform limit data 502 can be indicative of an acceleration limit and one or more steering limits of the autonomous vehicle. In some implementations, the one or more steering limits can include at least one of a steering angle limit or a steering angle rate limit. The platform limit data 502 may be determined based on vehicle capabilities, cargo load, weight distribution, regulations, laws, vehicle safety terms, or other data.

In some implementations, the method 1300 can include obtaining sensor data via the one or more sensors and generating the vehicle state data 505 based on the sensor data. For example, the autonomous vehicle can generate or obtain current or historical speed data via a speedometer. In some implementations, the method may include obtaining motion data via one or more inertial measurement units on the autonomous vehicle. The sensor data may include image data, thermal data, motion data, or other data.

At 1304, the method 1300 can include generating a velocity profile 514 and a lateral profile 516 associated with the autonomous vehicle. The computing system can generate the velocity profile 514 and the lateral profile 516 based on the road data 508, vehicle state data 505, and platform limit data 502. The velocity profile 514 can indicate a range of velocities performable by the autonomous vehicle based on the state of the autonomous vehicle and the acceleration limit. In some implementations, the velocity profile 514 can include a range of velocities, a range of accelerations, or a range of jerks. The range of velocities 512 may be descriptive of a minimum velocity and a maximum velocity for the autonomous vehicle based on the road data 508, vehicle state data 505, and platform limit data 502. The range of accelerations 510 may be descriptive of a minimum acceleration and a maximum acceleration for the autonomous vehicle based on the road data 508, vehicle state data 505, and platform limit data 502. The range of jerks may be descriptive of a minimum jerk and a maximum jerk for the autonomous vehicle based on the road data 508, vehicle state data 505, and platform limit data 502. The lateral profile 516 can indicate a range of lateral offsets from a path of the autonomous vehicle that are performable by the autonomous vehicle based on the state of the autonomous vehicle and the one or more steering limits. The lateral profile 516 can include, for example, a left offset, a right offset, or lateral rate of change range, as described herein.

In some implementations, the range of velocities of the velocity profile 514 can be performable by the autonomous vehicle at a target time based on the state of the autonomous vehicle, the acceleration limit, the one or more steering limits, and the characteristics of the one or more roads. The range of velocities can be a range of dynamically feasible velocities based on the vehicle details, or the environment details. The range of velocities can be determined by first calculating a jerk range based on a jerk limit associated with the platform limit data 502, then determining an acceleration range 510 from the jerk range, and then determining the velocity range from the acceleration range 510.

In some implementations, the range of lateral offsets of the lateral profile 516 may be achievable by the autonomous vehicle at a target distance based on the state of the autonomous vehicle, the acceleration limit, the one or more steering limits, and the characteristics of the one or more roads. The range of lateral offsets can be a range of dynamically feasible side-to-side offsets based on the vehicle details (e.g., vehicle suspension or mechanical limitations) or the environment details (e.g., road gradient, lane size, other vehicles' locations, road curvature, or weather conditions). The lateral profile 516 can be indicative of a lateral motion range descriptive of a left steering limit and a right steering limit. By way of example, the lateral profile 516 can indicate the range of distances offset to the left and right of a basis path that the autonomous vehicle can reach by the target distance, given the current velocity/acceleration of the vehicle, the physical mechanical limits on the acceleration of the vehicle. The lateral profile 516 can be indicative of the left to right steering angles and rates that the vehicle can execute by the target distance, to reach the offsets.

In some implementations, generating the velocity profile 514 can include determining a jerk range based on the vehicle state data 505 and the platform limit data 502. The jerk range can be indicative of a maximum jerk and a minimum jerk based on the initial velocity and the initial acceleration. The computing system can determine an acceleration range 510 510 based on the vehicle state data 505, the platform limit data 502, and the jerk range. The acceleration range 510 can be indicative of a maximum acceleration and a minimum acceleration that is determined based on the jerk range, the acceleration limit, the initial velocity/acceleration. The computing system can determine the range of velocities based on the acceleration range 510, the jerk range, the acceleration limit, the initial velocity, and the initial acceleration. The range of velocities can be indicative of a maximum velocity and a minimum velocity that the autonomous vehicle can achieve by a target time or distance.

At 1306, the method 1300 can include generating a plurality of initial candidate trajectories 418 for the autonomous vehicle. The computing system can generate the plurality of initial candidate trajectories 418 for the autonomous vehicle based on the velocity profile 514 and the lateral profile 516. The plurality of initial candidate trajectories 418 can be feasible for execution by the autonomous vehicle based on dynamic limits associated with velocities and lateral movement described in the velocity profile 514 and the lateral profile 516. The computing system can leverage the velocity profile 514 and the lateral profile 516 as generation (or sampling) parameters that limit the generation of the initial candidate trajectories to only trajectories that maintains velocities within the range of velocities and maintains lateral offsets within the range of offsets.

By way of example, or the trajectory sampler 416 of the computing system can parameterize the generation (or sampling) based on the velocity range 512 of the velocity profile 514 and the lateral offset range of the lateral profile 516. In particular, the inputs to or the weights of the trajectory sampler 416 may include or be based on the velocity profile 514 and the lateral profile 516. Each trajectory can include velocity values for each position of a path within the prediction time horizon. Moreover, each trajectory can include lateral positioning which may vary as the trajectory progresses along the path.

At 1308, the method 1300 can include determining, from among the plurality of initial candidate trajectories, a selected trajectory for the autonomous vehicle. The computing system may determine the selected trajectory based on evaluating or ranking the plurality of initial candidate trajectories 418 via a ranging engine. The plurality of initial candidate trajectories 418 may be evaluated or ranked based on potential interference with other objects, lane change maneuvers, quick time events (e.g., sudden breaking due to potential collision, sudden acceleration during a lane change to avoid being rear ended, or sudden lane change to avoid road debris), fuel inefficiencies, or other metrics. By way of example, an initial candidate trajectory that quickly transitions the autonomous vehicle to an adjacent lane into a tighter space ahead of a vehicle may be ranked lower than another initial trajectory that may have the autonomous vehicle wait and smoothly changes lane to queue behind the other vehicle.

At 1310, the method 1300 can include providing one or more instructions to control a motion of the autonomous vehicle in accordance with the selected trajectory. The motion control can include transmitting instructions from the motion planning system to the motion controlling system. This instructions may include or otherwise be representation of the selected trajectory and may include a specific sequence of velocities, lateral changes, or other features in accordance therewith.

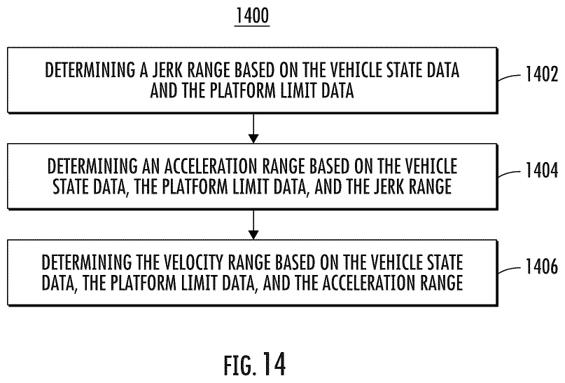

FIG. 14 is a flowchart of an example method 1400 for generating a velocity profile 514, according to some implementations of the present disclosure. In particular, the method 1300 can include performing the method 1400 for generating a velocity profile 514 and a lateral profile 516 associated with the autonomous vehicle.

At 1402, the method 1400 can include determining a jerk range based on the vehicle state data 505 and the platform limit data 502. The state of the autonomous vehicle can include an initial velocity and an initial acceleration of the autonomous vehicle. The jerk range can be indicative of a maximum jerk and a minimum jerk based on the initial velocity and the initial acceleration.

At 1404, the method 1400 can include determining an acceleration range 510 based on the vehicle state data 505, the platform limit data 502, and the jerk range. As described herein, the acceleration range 510 can be indicative of a maximum acceleration and a minimum acceleration that is determined based on the jerk range, the acceleration limit, the initial velocity, and the initial acceleration.

At 1406, the method 1400 can include determining the velocity range 512 based on the vehicle state data 505, the platform limit data 502, and the acceleration range 510. As described herein, the range of velocities can be indicative of a maximum velocity and a minimum velocity based on the acceleration range 510, the jerk range, the acceleration limit, the initial velocity, and the initial acceleration.

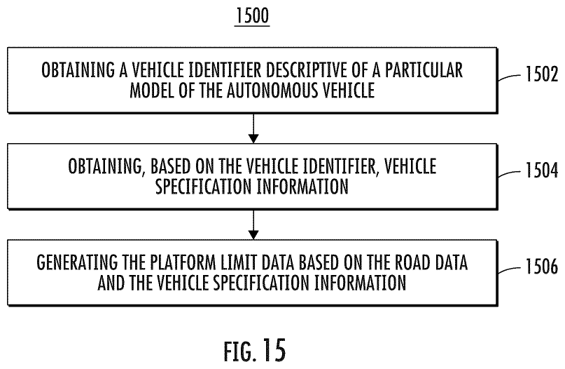

FIG. 15 is a flowchart of an example method 1500 for generating platform limit data 502 based on vehicle identifiers, according to some implementations of the present disclosure. In particular, the method 1300 can include performing the method 1500 for obtaining road data 508, vehicle state data 505, and platform limit data 502 associated with an autonomous vehicle at 1302.

At 1502, the method 1500 can include obtaining a vehicle identifier descriptive of a particular model of the autonomous vehicle. The vehicle identifier may include a label of a vehicle model identification for the autonomous vehicle, a vehicle identification number, or other identifiers. The vehicle identifier can be stored in an accessible database (e.g., in an onboard memory resource, remote memory resource) and accessed with a query. The vehicle identifier may be obtained when the autonomous vehicle is initially configured prior to road launch, when the vehicle is turned on, or at another time.

At 1504, the method 1500 can include obtaining, based on the vehicle identifier, vehicle specification information. The vehicle specification information can be indicative of an engine of the autonomous vehicle, a size of the autonomous vehicle, and a weight of the autonomous vehicle. In some implementations, the vehicle specification information may include suspension details, vehicle weight distribution details, the driving axle (e.g., front-wheel drive, rear-wheel drive, all-wheel drive, four-wheel drive, or other configurations).

At 1506, the method 1500 can include generating the platform limit data 502 based on the road data 508 and the vehicle specification information. For example, the platform limit data 502 may be generated based on the road gradient, road curvature, road conditions, the engine details, the size of the vehicle, the weight of the vehicle, or other vehicle information.

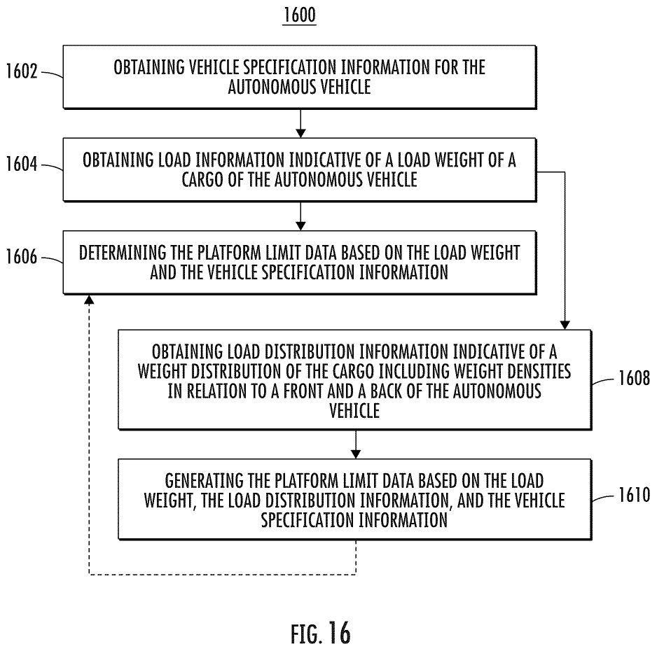

FIG. 16 is a flowchart of an example method 1600 for generating platform limit data 502 based on load data, according to some implementations of the present disclosure. In particular, the method 1300 can include performing the method 1600 for obtaining road data 508, vehicle state data 505, and platform limit data 502 associated with an autonomous vehicle at 1302.

At 1602, the method 1600 can include obtaining vehicle specification information for the autonomous vehicle. The vehicle specification information can be indicative of an engine of the autonomous vehicle, a size of the autonomous vehicle, and a weight of the autonomous vehicle. The vehicle specification information can be indicative of an engine of the autonomous vehicle, vehicle towing capacity, vehicle torque, vehicle horsepower, a size of the autonomous vehicle, and a weight of the autonomous vehicle. In some implementations, the vehicle specification information may include suspension details, vehicle weight distribution details, the driving axle (e.g., front-wheel drive, rear-wheel drive, all-wheel drive, four-wheel drive, or other configurations).

At 1604, the method 1600 can include obtaining load information indicative of a load weight of a cargo of the autonomous vehicle. The load weight may be descriptive of a weight of a trailer. The load weight may be obtained via a communication with a computing system of a weighing station. In some implementations, the load weight may be associated with a load inventory.

At 1606, the method 1600 can include determining the platform limit data 502 based on the load weight and the vehicle specification information. The autonomous vehicle may determine the platform limit data 502 based on determining a vehicle tipping point, engine limits, or other data associated with the load weight and the vehicle specification information.

In some implementations, determining the platform limit data 502 based on the load weight and the vehicle specification information can include generating platform limit data 502 based in part on load distribution information (e.g., as depicted at 1608 and 1610).

At 1608, the method 1600 can include obtaining load distribution information indicative of a weight distribution of the cargo including weight densities in relation to a front and a back of the autonomous vehicle. The load distribution information may be generated based on a user input or processing an image of the trailer with a machine-learned model.

At 1610, the method 1600 can include generating the platform limit data 502 based on the load weight, the load distribution information, and the vehicle specification information. In some implementations, the autonomous vehicle may have one or more initial platform limits that are adjusted based on the load weight and the load distribution information.

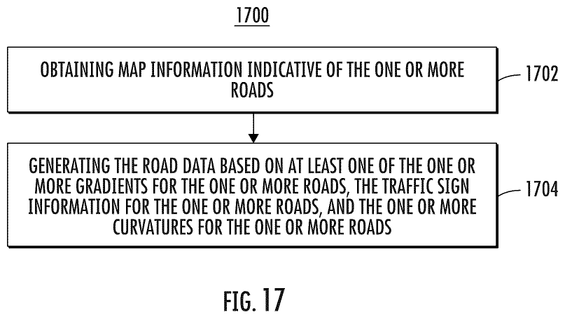

FIG. 17 is a flowchart of an example method 1700 for generating road data 508, according to some implementations of the present disclosure. In particular, the method 1300 can include performing the method 1600 for obtaining road data 508, vehicle state data 505, and platform limit data 502 associated with an autonomous vehicle at 1302.

At 1702, the method 1700 can include obtaining map information indicative of the one or more roads. The map information can be indicative of at least one of one or more gradients for the one or more roads, traffic sign information for the one or more roads, or one or more curvatures for the one or more roads. The map information may be obtained from a database of a plurality of map datasets. The map information may include metadata, latent encoding data, image data, text data, statistical data, three-dimensional point cloud data, or other data.

At 1704, the method 1700 can include generating the road data 508 based on at least one of the one or more gradients for the one or more roads, the traffic sign information for the one or more roads, and the one or more curvatures for the one or more roads. The autonomous vehicle may generate the road data 508 based on aggregating or concatenating feature sets to generate a three-dimensional representation of road information. In some implementations, the autonomous vehicle may generate the road data 508 based on the map information and sensor data descriptive of the environment. The sensor data may include image data, lidar data, or other data.

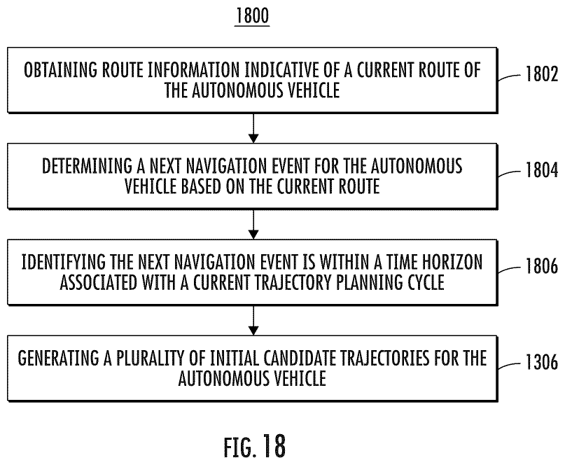

FIG. 18 is a flowchart of an example method 1800 for generating initial candidate trajectories, according to some implementations of the present disclosure. In particular, the method 1300 can include performing the method 1800 to determine a next navigation event is within a time horizon, which can be utilized for the candidate trajectory generation.

At 1802, the method 1800 can include obtaining route information indicative of a current route of the autonomous vehicle. The route information can be obtained from a global positioning system for the autonomous vehicle. The current route may include a beginning location and a plurality of navigation events for reaching a target location.

At 1804, the method 1800 can include determining a next navigation event for the autonomous vehicle based on the current route. The next navigation event can be determined based on the route information. The next navigation event can be descriptive of a next turn for the current route. The next navigation event may occur at a stop light, a ramp, a stop sign, or other location.

At 1806, the method 1800 can include identifying the next navigation event is within a time horizon associated with a current trajectory planning cycle. The time horizon may be five seconds, ten seconds, twenty-five seconds, or other time span. Each of the plurality of initial candidate trajectories 418 can be associated with a time length meeting the set time horizon.

At 1306, the method 1800 may include generating a plurality of initial candidate trajectories 418 for the autonomous vehicle. The method 1800 nay include generating the plurality of initial candidate trajectories 418 also based on the next navigation event.

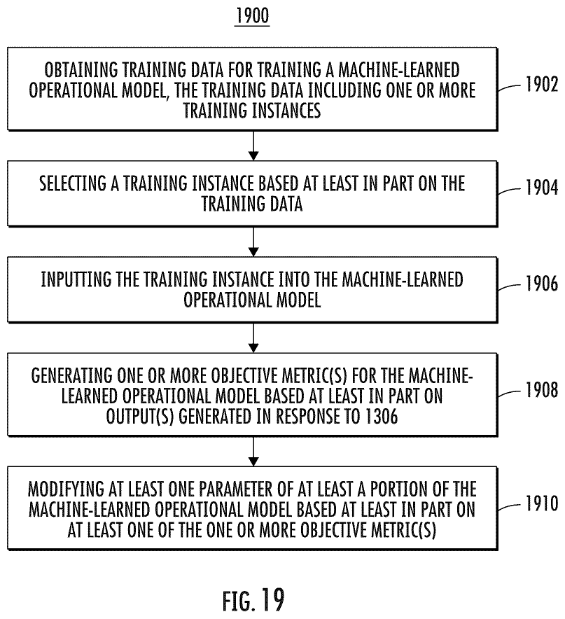

FIG. 19 depicts a flowchart of a method 1900 for training one or more machine-learned operational models according to aspects of the present disclosure. For instance, an operational system (e.g., a profile generator operator or a trajectory generator (or sampler)) can include a machine-learned operational model.

One or more portion(s) of the method 1900 can be implemented by a computing system that includes one or more computing devices such as, for example, the computing systems described with reference to the other figures (e.g., autonomous platform 110, vehicle computing system 180, remote system(s) 160, a system of FIG. 22, etc.). Each respective portion of the method 1900 can be performed by any (or any combination) of one or more computing devices. Moreover, one or more portion(s) of the method 1500 can be implemented on the hardware components of the device(s) described herein (e.g., as in FIGS. 1, 2, 22, etc.), for example, to validate one or more systems or models. FIG. 19 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 19 is described with reference to elements/terms described with respect to other systems and figures for exemplary illustrated purposes and is not meant to be limiting. One or more portions of method 1500 can be performed additionally, or alternatively, by other systems.

At 1902, the method 1900 can include obtaining training data for training a machine-learned operational model. The training data can include a plurality of training instances (e.g., training examples including a velocity profile 514, a lateral profile 516, and one or more ground truth trajectories that meet parameters set forth by the velocity profile 514 and the lateral profile 516). The machine-learned operational model can include, for example, a trajectory sampler model, as described herein.

The training data can be collected using one or more autonomous platforms (e.g., autonomous platform 110) or the sensors thereof as the autonomous platform is within its environment. By way of example, the training data can be collected using one or more autonomous vehicle(s) (e.g., autonomous platform 110, autonomous vehicle 310, autonomous vehicle 350, etc.) or sensors thereof as the vehicle(s) operates along one or more travel ways. In some examples, the training data can be collected using other sensors, such as mobile-device-based sensors, ground-based sensors, aerial-based sensors, satellite-based sensors, or substantially any sensor interface configured for obtaining or recording measured data.

The training data can include a plurality of training sequences divided between multiple datasets (e.g., a training dataset, a validation dataset, or testing dataset). Each training sequence can include a plurality of pre-recorded perception datapoints, point clouds, images, etc. In some implementations, each sequence can include LIDAR point clouds (e.g., collected using LIDAR sensors of an autonomous platform), images (e.g., collected using mono or stereo imaging sensors, etc.). For instance, in some implementations, a plurality of images can be scaled for training and evaluation.

At 1904, the method 1900 can include selecting a training instance based at least in part on the training data.

At 1906, the method 1900 can include inputting the training instance into the machine-learned operational model.

At 1908, the method 1900 can include generating one or more loss metric(s) or one or more objective(s) for the machine-learned operational model based on output(s) of at least a portion of the machine-learned operational model and label(s) associated with the training instances.

At 1910, the method 1900 can include modifying at least one parameter of at least a portion of the machine-learned operational model based at least in part on at least one of the loss metric(s) or at least one of the objective(s). For example, a computing system can modify at least a portion of the machine-learned operational model based at least in part on at least one of the loss metric(s) or at least one of the objective(s).

In some implementations, the machine-learned operational model can be trained in an end-to-end manner. For example, in some implementations, the machine-learned operational model can be fully differentiable.

After being updated, the operational model or the operational system including the operational model can be provided for validation.

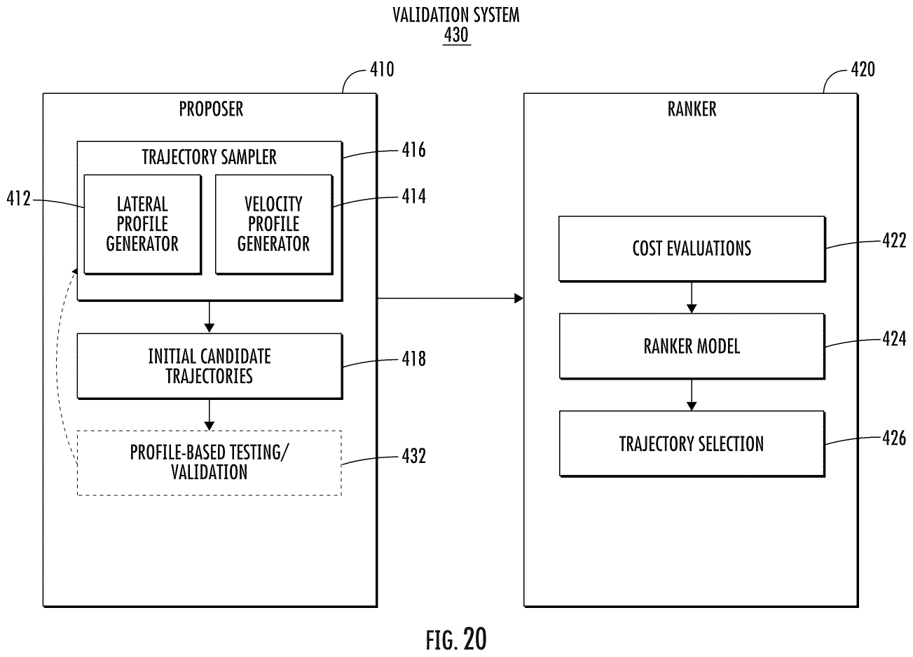

FIG. 20 is a block diagram of an example validation system 430, according to some implementations of the present disclosure. In particular, the validation system 430 can leverage the velocity profile 514 or the lateral profile 516 to test or validate that the sampled (or generated) candidate trajectories are dynamically feasible.

For example, the validation system 430 can include a similar proposer system 410 and a similar ranker system 420 to the parameter-based sampling system 400; however, the use and timing of the velocity profile 514 and the lateral profile 516 may differ from the parameter-based sampling system 400. In particular, the validation system 530 may be leveraged to validate the quality of outputs of the proposer system 410. The proposer system 410 may generate a plurality of initial candidate trajectories 418 via a trajectory sampler 416 (with or without the use of the profiles). The velocity profile 514 and the lateral profile 516 can be utilized to determine whether the plurality of initial candidate trajectories 418 meet the parameters set forth by the profiles.

In some implementations, the proposer system 410 may include the lateral profile generator 412 and the velocity profile generator 414 within the trajectory sampler 416. The lateral profile generator 412 can generate a lateral profile 516. The velocity profile generator 414 can generate a velocity profile 514. In some implementations, the trajectory sampler 416 can leverage the lateral profile generator 412 and the velocity profile generator 414 to generate profiles that can be leveraged for trajectory validation.

The lateral profile 516, the velocity profile 514, or the cost evaluations 422 may be processed by a ranker model 424 of the ranker system 420 to rank or filter the plurality of initial candidate trajectories 418. The ranking model 424 may output rankings or the filtered results, which can inform the trajectory selection 426 for determining a selected trajectory for execution.

The velocity profile generator 414 or lateral profile generator 412 may be in the proposer system 410. The proposer system 410 can generate a velocity profile 514 or a lateral profile 516 with the velocity profile generator 414 or lateral profile generator 412, respectively. The proposer system 410 can perform profile-based testing/validation 432 of the plurality of initial candidate trajectories 418 based on the velocity profile 514 or the lateral profile 516. An initial candidate trajectory can be determined to be valid based on determining the respective initial candidate trajectory includes velocities, accelerations, jerks, lateral movements, and lateral rate of changes that fall within the parameters set forth by the velocity profile 514. The initial candidate trajectory can be determined to be invalid based on the respective initial candidate trajectory having a velocity at some point not being within the velocity range 512, an acceleration at some point not being within the acceleration range 510, a jerk at some point not being within the jerk range, a lateral offset at some point not being within the lateral offset range, or a lateral offset rate of change at some point not being within the lateral offset rate of change range.

Based on the profile-based testing/validation 432, the proposer system 410 may adjust one or more parameters of the trajectory sampler 416 to perform a new adjusted generation process for generating a plurality of second candidate trajectories. Alternatively or additionally, the proposer system 420 may adjust parameters of the trajectory sampler 416 or adjust the input for the trajectory sampler 416 to generate a plurality of supplementary candidate trajectories to complement or replace the plurality of initial candidate trajectories 418. The process may be performed iteratively to tune the trajectory sampler 416 or refine the plurality of initial candidate trajectories 418.

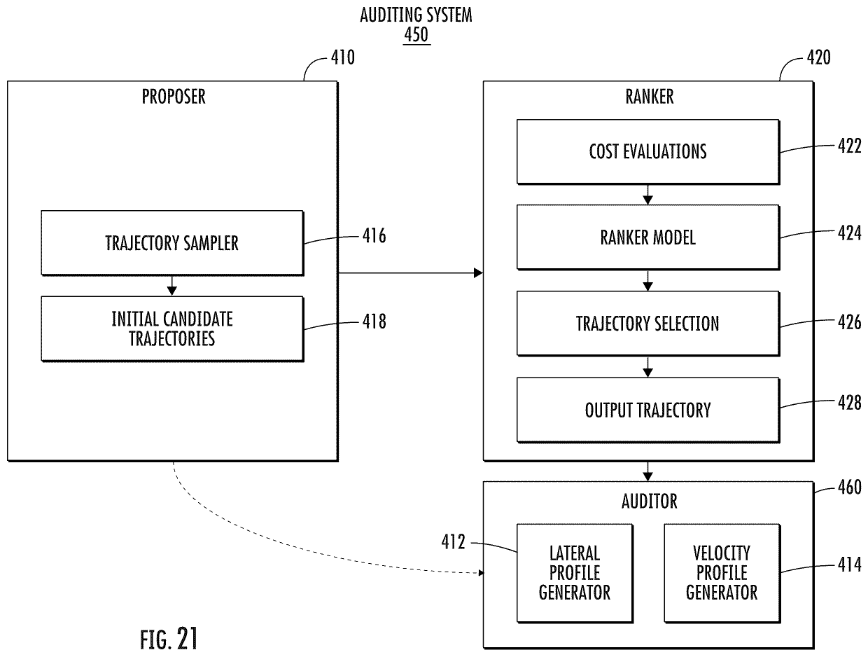

FIG. 21 is a block diagram of an example auditing system 450, according to some implementations of the present disclosure. In particular, the auditing system 450 can leverage the velocity profile 514 or the lateral profile 516 to audit the output trajectories of a motion planning system to determine whether the system generates trajectories that are dynamically feasible. The auditing system 450 may be utilized by an autonomous vehicle manufacturer or user to audit their system. Alternatively or additionally, the auditing system 450 may be utilized by a third party (e.g., a regulatory entity) to evaluate the motion planning system. This may be used, for example, in a certification or permitting process for autonomous vehicles.

For example, the auditing system 450 can include a similar proposer system 410 and a similar ranker system 420 to the parameter-based sampling system 400; however, the use and timing of the velocity profile 514 and the lateral profile 516 may differ from the parameter-based sampling system 400. In particular, the proposer system 410 may generate a plurality of initial candidate trajectories 418 via a trajectory sampler 416. The ranker system 420 can evaluate or rank the plurality of initial candidate trajectories 418. The ranker system 420 may leverage the cost evaluations 422 and the ranker model 424 to condition or perform the trajectory selection 426 to determine an output trajectory 428 (e.g., a selected trajectory). The ranker system 420 can provide the output trajectory 428 to an auditor system 460.

The auditor system 460 can include a velocity profile generator 414 or a lateral profile generator 412 to generate a velocity profile 514 or a lateral profile 516 to be utilized to audit the proposer system 410, the ranker system 420, or the motion planning system as a whole. The velocity profile 514 and the lateral profile 516 can be utilized to determine whether the trajectories or of the proposer system 410 or the ranker system 420 meet the parameters set forth by the profiles.

By way of example, the auditor system 460 may be configured to receive the plurality of initial candidate trajectories 418 from the proposer system 410. The auditor system 460 can determine whether the proposer system 410 is generating trajectories that conform to the parameters of the velocity profile 514 or the lateral profile 516. For instance, the auditor system 460 can evaluate the trajectories to determine whether the velocities of the trajectories are within the velocity ranges 512 of the velocity profiles 514 and may evaluate the trajectories to determine whether the lateral movements of the trajectories are within the lateral offset ranges of the lateral profiles 516. For example, the auditor system 460 may determine a proposer system 410 is flawed if an initial candidate trajectory 418 includes a velocity that is not within the velocity range 512 as the initial candidate trajectory 418 may be dynamically infeasible or may cause undue burden on the autonomous vehicle. The auditor system 460 may be auditing a proposer system 410 to verify that all or a percentage of the plurality of initial candidate trajectories 418 conform with the velocity profile 514 and the lateral profile 516. In some implementations, the auditor system 460 may provide a proposer system 410 a fail rating if a certain percentage of trajectories are determined to not be dynamically feasible.

In some implementations, the auditor system 460 may be configured to receive the output trajectory 428 from the ranker system 420. The auditor system 460 can determine whether the ranker system 410 or the motion planning system is generating outputs that conform to the parameters of the velocity profile 514 or the lateral profile 516. For instance, the auditor system 460 can evaluate the trajectories to determine whether the velocities of the trajectories are within the velocity ranges 512 of the velocity profiles 514 and may evaluate the trajectories to determine whether the lateral movements of the trajectories are within the lateral offset ranges of the lateral profiles 516. For example, the auditor system 460 may determine a motion planning system is flawed if an output trajectory 428 includes a velocity that is not within the velocity range 512 as the output trajectory 428 may be dynamically infeasible or may cause undue burden on the autonomous vehicle. The auditor system 460 may be auditing a motion planning system to verify that all or a percentage of output trajectories 428 conform with the velocity profile 514 and the lateral profile 516. In some implementations, the auditor system 460 may provide a motion planning system a fail rating if a certain percentage of trajectories are determined to not be dynamically feasible.

The auditor system 460 may be configured to be compatible with a plurality of different motion planning system configurations in order to perform auditing on motion planning systems agnostic of the underlying features of the motion planning system. The auditor system 560 may be leveraged for quality control, regulatory review, or other auditing tasks.

The auditor system 460 can be configured to perform a filtering operation within the trajectory selection 426 of the ranker system 420 or separately. The proposer system 410, the ranker system 420, or the auditor system 460 may leverage the lateral profile generator 412 or the velocity profile generator 414 to generate a lateral profile 516 or a velocity profile 514, which can then be leveraged to filter initial candidate trajectories 418 or refined candidate trajectories. The profile-based filtering can be performed at the trajectory sampler 416 block or later in the process including at the ranker model 424, trajectory selection 426, or the auditor system 460. In some implementations, the filtering can be performed at a plurality of different instances throughout the trajectory planning process. In some implementations, the filtering can include cost value-based filtering, which can filter out trajectories based on cost values that do not meet one or more cost value thresholds.

FIG. 22 is a block diagram of an example computing ecosystem 12 according to example implementations of the present disclosure. The example computing ecosystem 12 may include a first computing system 20 and a second computing system 40 that are communicatively coupled over one or more networks 60. In some implementations, the first computing system 20 or the second computing 40 may implement one or more of the systems, operations, or functionalities described herein for validating one or more systems or operational systems (e.g., the remote system(s) 160, the onboard computing system(s) 180, the autonomy system(s) 200).

In some implementations, the first computing system 20 may be included in an autonomous platform and be utilized to perform the functions of an autonomous platform as described herein. For example, the first computing system 20 may be located onboard an autonomous vehicle and implement autonomy system(s) for autonomously operating the autonomous vehicle. In some implementations, the first computing system 20 may represent the entire onboard computing system or a portion thereof (e.g., the localization system 230, the perception system 240, the planning system 250, the control system 260, or a combination thereof). In other implementations, the first computing system 20 may not be located onboard an autonomous platform. The first computing system 20 may include one or more distinct physical computing devices 21.

The first computing system 20 (e.g., the computing device(s) 21 thereof) may include one or more processors 22 and a memory 23. The one or more processors 22 may be any suitable processing device (e.g., a processor core, a microprocessor, an ASIC, a FPGA, a controller, a microcontroller) and may be one processor or a plurality of processors that are operatively connected. The memory 23 may include one or more non-transitory computer-readable storage media, such as RAM, ROM, EEPROM, EPROM, one or more memory devices, flash memory devices, or combinations thereof.

The memory 23 may store information that may be accessed by the one or more processors 22. For instance, the memory 23 (e.g., one or more non-transitory computer-readable storage media, memory devices) may store data 24 that may be obtained (e.g., received, accessed, written, manipulated, created, generated, stored, pulled, downloaded). The data 24 may include, for instance, sensor data, map data, data associated with autonomy functions (e.g., data associated with the perception, planning, or control functions), simulation data, or any data or information described herein. In some implementations, the first computing system 20 may obtain data from one or more memory device(s) that are remote from the first computing system 20.

The memory 23 may store computer-readable instructions 25 that may be executed by the one or more processors 22. The instructions 25 may be software written in any suitable programming language or may be implemented in hardware. Additionally, or alternatively, the instructions 25 may be executed in logically or virtually separate threads on the processor(s) 22.

For example, the memory 23 may store instructions 25 that are executable by one or more processors (e.g., by the one or more processors 22, by one or more other processors) to perform (e.g., with the computing device(s) 21, the first computing system 20, or other system(s) having processors executing the instructions) any of the operations, functions, or methods/processes (or portions thereof) described herein. For example, operations may include implementing system validation (e.g., as described herein).

In some implementations, the first computing system 20 may store or include one or more models 26. In some implementations, the models 26 may be or may otherwise include one or more machine-learned models (e.g., a machine-learned shape detection model). As examples, the models 26 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 may include one or more models for implementing subsystems of the autonomy system(s) 200, including any of: the localization system 230, the perception system 240, the planning system 250, or the control system 260.

In some implementations, the first computing system 20 may obtain the one or more models 26 using communication interface(s) 27 to communicate with the second computing system 40 over the network(s) 60. For instance, the first computing system 20 may store the model(s) 26 (e.g., one or more machine-learned models) in the memory 23. The first computing system 20 may then use or otherwise implement the models 26 (e.g., by the processors 22). By way of example, the first computing system 20 may implement the model(s) 26 to localize an autonomous platform in an environment, perceive an autonomous platform's environment or objects therein, plan one or more future states of an autonomous platform for moving through an environment, control an autonomous platform for interacting with an environment, perform the techniques and processes described herein, or perform other functions.

The second computing system 40 may include one or more computing devices 41. The second computing system 40 may include one or more processors 42 and a memory 43. The one or more processors 42 may be any suitable processing device (e.g., a processor core, a microprocessor, an ASIC, a FPGA, a controller, a microcontroller) and may be one processor or a plurality of processors that are operatively connected. The memory 43 may include one or more non-transitory computer-readable storage media, such as RAM, ROM, EEPROM, EPROM, one or more memory devices, flash memory devices, and combinations thereof.

The memory 43 may store information that may be accessed by the one or more processors 42. For instance, the memory 43 (e.g., one or more non-transitory computer-readable storage media, memory devices) may store data 44 that may be obtained. The data 44 may include, for instance, sensor data, model parameters, map data, simulation data, simulated environmental scenes, simulated sensor data, data associated with vehicle trips/services, or any data or information described herein. In some implementations, the second computing system 40 may obtain data from one or more memory devices that are remote from the second computing system 40.

The memory 43 may also store computer-readable instructions 45 that may be executed by the one or more processors 42. The instructions 45 may be software written in any suitable programming language or may be implemented in hardware. Additionally, or alternatively, the instructions 45 may be executed in logically or virtually separate threads on the processors 42.

For example, the memory 43 may store instructions 45 that are executable (e.g., by the one or more processors 42, by the one or more processors 22, by one or more other processors) to perform (e.g., with the computing devices 41, the second computing system 40, or other system(s) having processors for executing the instructions, such as computing devices 21 or the first computing system 20) any of the operations, functions, or methods/processes described herein. This may include, for example, the functionality of the autonomy system(s) 200 (e.g., localization, perception, planning, control) or other functionality associated with an autonomous platform (e.g., remote assistance, mapping, fleet management, trip/service assignment and matching). This may also include, for example, validating a machined-learned operational system.

In some implementations, the second computing system 40 may include one or more server computing devices. In the event that the second computing system 40 includes multiple server computing devices, such server computing devices may operate according to various computing architectures, including, for example, sequential computing architectures, parallel computing architectures, or some combination thereof.

Additionally, or alternatively to, the model(s) 26 at the first computing system 20, the second computing system 40 may include one or more models 46. As examples, the model(s) 46 may be or may otherwise include various machine-learned models (e.g., a machine-learned shape detection model) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 may include one or more models of the autonomy system(s) 200.

In some implementations, the second computing system 40 or the first computing system 20 may train one or more machine-learned models of the model(s) 26 or the model(s) 46 through the use of one or more model trainers 47 and training data 48. The model trainer(s) 47 may train any one of the model(s) 26 or the model(s) 46 using one or more training or learning algorithms. One example training technique is backwards propagation of errors. In some implementations, the model trainer(s) 47 may perform supervised training techniques using labeled training data. In other implementations, the model trainer(s) 47 may perform unsupervised training techniques using unlabeled training data. In some implementations, the training data 48 may include simulated training data (e.g., training data obtained from simulated scenarios, inputs, configurations, environments). In some implementations, the second computing system 40 may implement simulations for obtaining the training data 48 or for implementing the model trainer(s) 47 for training or testing the model(s) 26 or the model(s) 46. By way of example, the model trainer(s) 47 may train one or more components of a machine-learned model for the autonomy system(s) 200 through unsupervised training techniques using an objective function (e.g., costs, rewards, heuristics, constraints). In some implementations, the model trainer(s) 47 may perform a number of generalization techniques to improve the generalization capability of the model(s) being trained. Generalization techniques include weight decays, dropouts, or other techniques.

For example, in some implementations, the second computing system 40 may generate training data 48 according to example aspects of the present disclosure. For instance, the second computing system 40 may generate training data 48. For instance, the second computing system 40 may implement methods according to example aspects of the present disclosure. The second computing system 40 may use the training data 48 to train model(s) 26. For example, in some implementations, the first computing system 20 may include a computing system onboard or otherwise associated with a real or simulated autonomous vehicle. In some implementations, model(s) 26 may include perception or machine vision model(s) configured for deployment onboard or in service of a real or simulated autonomous vehicle. In this manner, for instance, the second computing system 40 may provide a training pipeline for training model(s) 26.

The first computing system 20 and the second computing system 40 may each include communication interfaces 27 and 49, respectively. The communication interfaces 27, 49 may be used to communicate with each other or one or more other systems or devices, including systems or devices that are remotely located from the first computing system 20 or the second computing system 40. The communication interfaces 27, 49 may include any circuits, components, software, or other components for communicating with one or more networks (e.g., the network(s) 60). In some implementations, the communication interfaces 27, 49 may include, for example, one or more of a communications controller, receiver, transceiver, transmitter, port, conductors, software or hardware for communicating data.

The network(s) 60 may be any type of network or combination of networks that allows for communication between devices. In some implementations, the network(s) may include one or more of a local area network, wide area network, the Internet, secure network, cellular network, mesh network, peer-to-peer communication link or some combination thereof and may include any number of wired or wireless links. Communication over the network(s) 60 may be accomplished, for instance, through a network interface using any type of protocol, protection scheme, encoding, format, packaging, or combination thereof.

FIG. 22 illustrates one example computing ecosystem 10 that may be used to implement the present disclosure. Other systems may be used as well. For example, in some implementations, the first computing system 20 may include the model trainer(s) 47 and the training data 48. In such implementations, the model(s) 26, 46 may be both trained and used locally at the first computing system 20. As another example, in some implementations, the computing system 20 may not be connected to other computing systems. Additionally, components illustrated or discussed as being included in one of the computing systems 20 or 40 may instead be included in another one of the computing systems 20 or 40.

Computing tasks discussed herein as being performed at computing device(s) remote from the autonomous platform (e.g., autonomous vehicle) may instead be performed at the autonomous platform (e.g., via a vehicle computing system of the autonomous vehicle), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but”. It should be understood that such conjunctions are provided for explanatory purposes only. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. may be used to illustrate operations. Such identifiers are provided for the ease of the reader and do not denote a particular order of steps or operations. An operation illustrated by a list identifier of (a), (i), etc. may be performed before, after, or in parallel with another operation illustrated by a list identifier of (b), (ii), etc.

What is claimed is:

1. A computer-implemented method comprising:
obtaining road data, vehicle state data, and platform limit data associated with an autonomous vehicle, wherein the road data is indicative of one or more characteristics of one or more roads within an environment of the autonomous vehicle, wherein the vehicle state data is indicative of a state of the autonomous vehicle, and wherein the platform limit data is indicative of an acceleration limit and one or more steering limits of the autonomous vehicle;
based on the road data, vehicle state data, and platform limit data, generating a velocity profile and a lateral profile associated with the autonomous vehicle,
the velocity profile indicating a range of velocities performable by the autonomous vehicle based on the state of the autonomous vehicle and the acceleration limit,
the lateral profile indicating a range of lateral offsets from a path of the autonomous vehicle that are performable by the autonomous vehicle based on the state of the autonomous vehicle and the one or more steering limits;
based on the velocity profile and the lateral profile, generating a plurality of initial candidate trajectories for the autonomous vehicle, wherein the plurality of initial candidate trajectories are feasible for execution by the autonomous vehicle based on dynamic limits associated with velocities and lateral movement described in the velocity profile and the lateral profile;
determining, from among the plurality of initial candidate trajectories, a selected trajectory for the autonomous vehicle; and
providing one or more instructions to control a motion of the autonomous vehicle in accordance with the selected trajectory.

2. The computer-implemented method of claim 1, wherein the range of velocities of the velocity profile are performable by the autonomous vehicle at a target time based on the state of the autonomous vehicle, the acceleration limit, the one or more steering limits, and the characteristics of the one or more roads.

3. The computer-implemented method of claim 1, wherein the range of lateral offsets of the lateral profile are achievable by the autonomous vehicle at a target distance based on the state of the autonomous vehicle, the acceleration limit, the one or more steering limits, and the characteristics of the one or more roads.

4. The computer-implemented method of claim 1, wherein the one or more steering limits comprise at least one of a steering angle limit or a steering angle rate limit.

5. The computer-implemented method of claim 1, wherein the state of the autonomous vehicle comprises an initial velocity and an initial acceleration of the autonomous vehicle.

6. The computer-implemented method of claim 1, comprising:
determining a jerk range based on the vehicle state data and the platform limit data, wherein the jerk range is indicative of a maximum jerk and a minimum jerk based on an initial velocity and an initial acceleration.

7. The computer-implemented method of claim 1, comprising:
determining an acceleration range based on the vehicle state data, the platform limit data, and the jerk range, wherein the acceleration range is indicative of a maximum acceleration and a minimum acceleration that is determined based on a jerk range, the acceleration limit, an initial velocity, and an initial acceleration.

8. The computer-implemented method of claim 1, wherein the range of velocities is indicative of a maximum velocity and a minimum velocity based on an acceleration range, a jerk range, the acceleration limit, an initial velocity, and an initial acceleration.

9. The computer-implemented method of claim 1, wherein the lateral profile is indicative of a lateral motion range descriptive of a left steering limit and a right steering limit.

10. The computer-implemented method of claim 1, further comprising:
obtaining a vehicle identifier descriptive of a particular model of the autonomous vehicle;
obtaining, based on the vehicle identifier, vehicle specification information, wherein the vehicle specification information is indicative of an engine of the autonomous vehicle, a size of the autonomous vehicle, and a weight of the autonomous vehicle; and
generating the platform limit data based on the road data and the vehicle specification information.

11. The computer-implemented method of claim 1, further comprising:
obtaining vehicle specification information for the autonomous vehicle, wherein the vehicle specification information is indicative of an engine of the autonomous vehicle, a size of the autonomous vehicle, and a weight of the autonomous vehicle;
obtaining load information indicative of a load weight of a cargo of the autonomous vehicle; and
determining the platform limit data based on the load weight and the vehicle specification information.

12. The computer-implemented method of claim 11, further comprising:
obtaining load distribution information indicative of a weight distribution of the cargo comprising weight densities in relation to a front and a back of the autonomous vehicle; and
generating the platform limit data based on the load weight, the load distribution information, and the vehicle specification information.

13. The computer-implemented method of claim 1, further comprising:
obtaining map information indicative of the one or more roads, wherein the map information is indicative of at least one of one or more gradients for the one or more roads, traffic sign information for the one or more roads, or one or more curvatures for the one or more roads; and
generating the road data based on at least one of the one or more gradients for the one or more roads, the traffic sign information for the one or more roads, and the one or more curvatures for the one or more roads.

14. The computer-implemented method of claim 1, further comprising:
obtaining route information indicative of a current route of the autonomous vehicle;
based on the route information, determining a next navigation event for the autonomous vehicle based on the current route, wherein the next navigation event is descriptive of a next turn for the current route;
identifying the next navigation event is within a time horizon associated with a current trajectory planning cycle; and
generating the plurality of initial candidate trajectories also based on the next navigation event.

15. An autonomous vehicle control system for controlling an autonomous vehicle, the autonomous vehicle control system comprising:
one or more processors; and
one or more non-transitory computer-readable media storing instructions that are executable by the one or more processors to cause the autonomous vehicle control system to perform operations, the operations comprising:
obtaining road data, vehicle state data, and platform limit data associated with the autonomous vehicle, wherein the road data is indicative of one or more characteristics of one or more roads within an environment of the autonomous vehicle, wherein the vehicle state data is indicative of a state of the autonomous vehicle, and wherein the platform limit data is indicative of an acceleration limit and one or more steering limits of the autonomous vehicle;
based on the road data, vehicle state data, and platform limit data, generating a velocity profile and a lateral profile associated with the autonomous vehicle,
the velocity profile indicating a range of velocities performable by the autonomous vehicle based on the state of the autonomous vehicle and the acceleration limit,
the lateral profile indicating a range of lateral offsets from a path of the autonomous vehicle that are performable by the autonomous vehicle based on the state of the autonomous vehicle and the one or more steering limits;
based on the velocity profile and the lateral profile, generating a plurality of initial candidate trajectories for the autonomous vehicle, wherein the plurality of initial candidate trajectories are feasible for execution by the autonomous vehicle based on dynamic limits associated with velocities and lateral movement described in the velocity profile and the lateral profile;
determining, from among the plurality of initial candidate trajectories, a selected trajectory for the autonomous vehicle; and
providing one or more instructions to control a motion of the autonomous vehicle in accordance with the selected trajectory.

16. The autonomous vehicle of claim 15, further comprising one or more sensors, and wherein the operations further comprises:
obtaining sensor data via the one or more sensors; and
generating the vehicle state data based on the sensor data.

17. The autonomous vehicle of claim 15, wherein the range of velocities of the velocity profile are performable by the autonomous vehicle at a target time based on the initial state of the autonomous vehicle, the acceleration limit, the one or more steering limits, and the characteristics of the one or more roads.

18. The autonomous vehicle of claim 15, wherein the range of lateral offsets of the lateral profile are performable by the autonomous vehicle at a target distance based on the initial state of the autonomous vehicle, the acceleration limit, the one or more steering limits, and the characteristics of the one or more roads.

19. The autonomous vehicle of claim 15, wherein the one or more steering limits comprise at least one of a steering angle limit or a steering angle rate limit, wherein the initial state of the autonomous vehicle comprises an initial velocity and an initial acceleration of the autonomous vehicle, and wherein the operations further comprise:
determining a jerk range based on the vehicle state data and the platform limit data, wherein the jerk range is descriptive indicative of a maximum jerk and a minimum jerk based on the steering angle rate limit, the initial velocity, and the initial acceleration.

20. One or more non-transitory computer-readable media storing instructions that are executable by one or more processors to cause an autonomous vehicle control system to perform operations, the operations comprising:
obtaining road data, vehicle state data, and platform limit data associated with an autonomous vehicle, wherein the road data is indicative of one or more characteristics of one or more roads within an environment of the autonomous vehicle, wherein the vehicle state data is indicative of a state of the autonomous vehicle, and wherein the platform limit data is indicative of an acceleration limit and one or more steering limits of the autonomous vehicle;
based on the road data, vehicle state data, and platform limit data, generating a velocity profile and a lateral profile associated with the autonomous vehicle,
the velocity profile indicating a range of velocities performable by the autonomous vehicle based on the state of the autonomous vehicle and the acceleration limit,
the lateral profile indicating a range of lateral offsets from a path of the autonomous vehicle that are performable by the autonomous vehicle based on the state of the autonomous vehicle and the one or more steering limits;
based on the velocity profile and the lateral profile, generating a plurality of initial candidate trajectories for the autonomous vehicle, wherein the plurality of initial candidate trajectories are feasible for execution by the autonomous vehicle based on dynamic limits associated with velocities and lateral movement described in the velocity profile and the lateral profile;
determining, from among the plurality of initial candidate trajectories, a selected trajectory for the autonomous vehicle; and
providing one or more instructions to control a motion of the autonomous vehicle in accordance with the selected trajectory.
